(19) United States
(12) Patent Application Publication
(10) Pub. No.: US 2026/0035766 A1
(43) Pub. Date: Feb. 5, 2026

(54) PROCESS AND SYSTEM FOR RECOVERING COPPER AND COBALT FROM SULFIDIC MATERIALS

(71) Applicant: Capstone Copper Corp., d/b/a Capstone Copper, Vancouver (CA)

(72) Inventors: Peter Amelunxen, Toronto (CA); Brandon Akerstrom, Gilbert, AZ (US); Jeffrey Todd Harvey, Lakewood, CO (US); Kain Nugent, Golden, CO (US); Willem P. Duyvesteyn, Reno, NV (US)

(21) Appl. No.: 19/288,565

(22) Filed: Aug. 1, 2025

Related U.S. Application Data
(60) Provisional application No. 63/678,956, filed on Aug. 2, 2024.

(51) Int. Cl. C22B 3/00; B01D 15/18; B01D 15/36; B01D 15/42; C22B 1/16; C22B 3/08; C22B 3/24; C22B 3/42; C22B 15/00; C22B 19/02; C22B 23/00

(52) U.S. Cl. CPC C22B 23/043; B01D 15/1871; B01D 15/361; B01D 15/424; C22B 1/16; C22B 3/08; C22B 3/24; C22B 3/42; C22B 15/0006; C22B 15/0071; C22B 15/0086; C22B 19/02; C22B 19/22; C22B 23/005; C22B 23/0453

(57) ABSTRACT

The present disclosure is directed to a process for recovering copper and cobalt from a copper and cobalt-containing sulfide ores and concentrates, particularly relatively low grade cobalt bearing sulfide ores and concentrates.

### CROSS-REFERENCE TO RELATED APPLICATIONS

The present application claims the benefit of and priority, under 35 U.S.C. § 119(e), to U.S. Provisional Application Ser. No. 63/678,956, filed on Aug. 2, 2024, entitled “PROCESS FOR RECOVERING COPPER AND COBALT FROM MIXED SULFIDE AND OXIDE,” the entire disclosure of which is hereby incorporated herein by reference, in its entirety, for all that it teaches and for all purposes.

### FIELD

The disclosure relates generally to recovery of base metals from base metal-containing sulfidic ores and concentrates and particularly to recovery of copper and cobalt from sulfide ores and concentrates.

### BACKGROUND

The recovery of cobalt from sulfide ores or concentrates can be achieved through several methods including pyrometallurgical and hydrometallurgical processes. In the pyrometallurgical system, the sulfide is often oxidized (roasted) that can subsequently be leached with dilute sulfuric acid to produce a cobalt sulfate. Hydrometallurgical processes can involve the use of pressure oxidation whereby the sulfide material is slurried and subjected to high temperature and pressure under an oxidizing environment which oxidizes the sulfide mineral liberating the cobalt. Biooxidation can also oxidize the sulfides by contacting the slurried material with bacteria and oxygen (air) in a stirred bioreactor (as was done at Kasese in Uganda in the 1980's). Sulfide minerals can also be oxidized in an acid heap leach environment by adding sulfide oxidizing microbes to the heap leach and providing air to the system.

Cobalt can be recovered from acidic leach solutions by a variety of systems including: (a) direct cobalt recovery methods (e.g., direct electrowinning of the cobalt sulfate from solution to produce cobalt metal—which process can have high power consumption and impurity issues, mainly iron, and direct precipitation of the cobalt sulfate from solution using a sulfidizing agent, such as NaHS, to produce a cobalt sulfide product (CoS)) and (b) cobalt concentration and recovery methods (e.g., initial concentration of the cobalt sulfate from the leach solution using solvent extraction (SX), initial concentration of the cobalt sulfate from the leach solution using ion exchange (IX), and other recovery methods such as recovery of the cobalt as metal from the concentrated SX or IX stream by electrowinning and recovery of the cobalt as metal from the concentrated SX or IX stream by precipitation using MgO and/or NaOH resulting in a salable Co(OH)₂ precipitate product)).

Electrowinning of cobalt sulfate to cobalt metal is a well-documented process with well-known technical issues. These issues include impurity contamination and cathode integrity and a complicated anode system among others.

These various processes can have a number of issues particularly for low grade sulfide ores. In particular, the processes, though typically technically viable, can have high capital and operating costs. The main issue is related to the grade of the feed material being treated: When the grade of the cobalt present in the ore is low, it is difficult to justify the capital and operating cost associated with conventional processes. When the grade of the cobalt present in the ore is low, the resulting leach solution grade will be low (e.g., cobalt tenor) making downstream cobalt recovery technically more difficult and costly. The processes can also suffer from high acid neutralization costs resulting from the sulfide oxidation.

### SUMMARY

These and other needs are addressed by the various embodiments and configurations of the present disclosure.

In an embodiment, the present disclosure is directed to a process comprising:
(a) floating a feed material comprising mainly non-sulfide gangue minerals and copper-containing sulfidic minerals, cobalt-containing sulfidic minerals, and iron pyrite at a pH of no more than about pH 10.5 to form a first separated portion comprising at least most of the copper-containing sulfidic minerals, cobalt-containing sulfidic minerals, and iron pyrite and a waste material;
(b) floating the first separated portion at a pH of more than about pH 10.5 to form a second separated portion comprising at least most of the copper-containing sulfidic minerals and a third separated portion comprising at least most of the cobalt-containing sulfidic minerals and iron pyrite and a portion of the copper-containing sulfidic minerals;
(c) contacting a lixiviant comprising H₂SO₄ and an oxidant with the third separated portion to form a pregnant leach solution comprising ferric iron and sulfuric acid from iron pyrite oxidation and, relative to the third separated portion, at least most of the copper in the copper-containing sulfidic minerals and cobalt in the cobalt-containing sulfidic minerals;
(d) treating the pregnant leach solution, by ion exchange or solvent extraction, to form a rich solution comprising at least most of the copper in the pregnant leach solution and a raffinate comprising a portion of the copper and ferric iron and at least most of the cobalt in the pregnant leach solution;
(c) removing, from at least a portion of the raffinate, at least most of the portion of the copper and ferric iron to form a purified raffinate; and
(f) recovering at least most of the cobalt from the purified raffinate to form a cobalt-rich solution and cobalt-barren solution.

In an embodiment, the present disclosure is directed to a process comprising:
(a) providing a cobalt-containing material comprising non-sulfidic gangue minerals, copper-containing sulfidic minerals, cobalt-containing sulfidic minerals, and iron pyrite;
(b) floating the cobalt-containing material at a pH of more than about pH 10.5 to form a first separated portion comprising at least most of the copper-containing sulfidic minerals in the cobalt-containing sulfidic minerals and a second separated portion comprising a portion of the copper-containing sulfidic minerals and at least most of the cobalt-containing sulfidic minerals and iron pyrite in the cobalt-containing material.
(c) contacting a lixiviant with the second separated portion to form a pregnant leach solution comprising ferric iron and sulfuric acid from iron pyrite oxidation and, relative to the second separated portion, at least most of the copper in the portion of the copper-containing sulfidic minerals and cobalt in the cobalt-containing sulfidic minerals;
(d) treating the pregnant leach solution, by ion exchange and/or solvent extraction, to form a rich solution comprising at least most of the copper in the pregnant leach solution and a raffinate comprising at least most of the cobalt and a portion of the copper and ferric iron in the pregnant leach solution;
(c) removing, from at least a portion of the raffinate, at least most of the copper and ferric iron to form a purified raffinate; and
(f) recovering at least most of the cobalt from the purified raffinate to form a cobalt product and cobalt-barren solution.

In an embodiment, the present disclosure is directed to a process comprising:
(a) forming a pregnant leach solution comprising dissolved copper, cobalt, and iron by leaching a feed material comprising a copper-containing sulfidic material and cobalt-containing sulfidic material;
(b) treating the pregnant leach solution, by ion exchange and/or solvent extraction, to form a rich solution comprising at least most of the copper in the pregnant leach solution and a raffinate comprising at least most of the cobalt and a portion of the copper and ferric iron in the pregnant leach solution;
(c) recycling a first portion of the raffinate to the forming to dissolve further copper and cobalt and provide a cobalt concentration in the pregnant leach solution of at least about 1 g/L;
(d) removing, from a second portion of the raffinate, at least most of the copper and ferric iron to form a purified raffinate, wherein the second portion comprises from about 5 to about 25% of the raffinate; and
(c) recovering at least most of the cobalt from the purified raffinate to form a cobalt product and cobalt-barren solution.

The present disclosure can provide a number of advantages depending on the particular configuration. By way of example, the process of the present disclosure can recover cobalt from an otherwise uneconomic low grade copper iron-sulfide bearing cleaner flotation tailings. By effectively recovering copper from a cleaner tailings stream, the overall copper grade-recovery curve of the flotation circuit (including bio-heap leach contribution) can be improved, potentially resulting in higher precious metals credits and lower shipping, treatment, refining, and contaminant penalties for the copper iron sulfide concentrate stream. The heap bioleach of a pyrite flotation concentrate generated from the tailings can oxidize the pyrite in the heap, forming sulfuric acid and ferric iron and releasing copper and cobalt into the pregnant leach solution (PLS). As will be appreciated, galvanic interactions between the copper-containing sulfidic minerals and pyrite minerals can oxidize the copper sulfide and release copper into the PLS. The in situ formation of sulfuric acid in the heap can not only reduce acid requirements but also increase copper recovery from copper oxide minerals in close contact with the pyrite. Removal of the cobalt from the copper heap leach solutions can obviate build up of dissolved cobalt in the copper recovery circuit, which complicates copper recovery. The heap can also provide a way to maximize the cobalt tenor by only bleeding out a portion of the cobalt into the recovery circuit, which improves the cobalt circuit recovery. Recovery of cobalt by continuous counter-current IX can significantly reduce resin and solution volumes while providing flexible process conditions and multiple adsorption passes.

The process of the present disclosure can retrofit existing copper oxide/sulfide ore processing facilities having ore crushing and agglomerating unit operations, oxide copper dynamic or static heap leaching (on off pad) (hereinafter “DLP”), solution handling via a series of ponds or other containment structures, reagent handling (e.g., acid) facilities, solvent extraction and electrowinning for copper cathode production, and a sulfide concentrating mill, particularly where the ore contains other valuable base metals such as cobalt. In the case of a static leach pad, aeration can become more complicated but air pipes can be added every few lifts to fulfill heap aeration requirements. The process thereby produces a new pyrite sulfide concentrate from the tailings stream of the concentrator (referred to as cleaner scavenger concentrate (CSC)). This new pyrite sulfide concentrate represents the rejected material from the flotation copper cleaner circuit. This CSC is added to the DLP feed as a high solid percentage slurry (typically >60% solids by weight) for further processing to recover the valuable base metals.

These and other advantages will be apparent from the disclosure of the disclosure contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Cobalt iron sulfide” refers to a compound comprising cobalt, iron, and sulfur and typically have the formula Co_{X}S_{Y}. Examples include FeCoS or CoFeS. Cobalt iron sulfide can have different stoichiometries such as Co₂Fe₂S₅. Cobalt can occur as a partial substitution of Fe in cobaltiferous pyrite. Although cobalt iron sulfide is referenced in this disclosure, it is to be understood that cobalt can also occur as CoS₂ or cattierite.

“Copper iron sulfide” refers to a compound comprising copper, iron, and sulfur. Examples include chalcocite, chalcopyrite, digenite, enargite, and bornite.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

“Nickel iron sulfide” refers to a compound comprising nickel, iron, and sulfur, such as pentlandite.

“Zinc iron sulfide” refers to a compound comprising zinc, iron, and sulfur and typically have the formula (Zn,Fe)S. It is to be understood that zinc iron sulfides are considered to include sphalerite and wurtzite.

Unless otherwise noted, an expression that a substance or material, regardless of phase, comprises or includes a particular element in the Periodic Table of Elements, such as aluminum, boron, scandium, calcium, europium. gold, hydrogen, iodine, lanthanum, molybdenum, niobium, oxygen, potassium, rhodium, samarium, tungsten, uranium, vanadium, and yttrium, is to be construed to include the element not only in its elemental form but also any other form of the element, including ions of the element and compounds and other molecules comprising the element.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

Numerous additional features and advantages are described herein and will be apparent to those skilled in the art upon consideration of the following Detailed Description and in view of the figures.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a flow chart showing an embodiment of a cobalt and copper recovery process in accordance with embodiments of the present disclosure;

FIG. 2 is a plot of copper extraction (%) (vertical axis) against days under leach (horizontal axis);

FIG. 3 is a plot of acid consumption (kg/L) (vertical axis) against days under irrigation (horizontal axis) for an aerated bioleach in the presence of a 2.5% pyrite (on quartz) content;

FIG. 4 is a plot of cobalt extraction (%) (vertical axis) against days under leach (horizontal axis);

FIG. 5 is a plot of cobalt concentration (g/L) (vertical axis) against time elapsed (hours) (horizontal axis);

FIG. 6 is a plot of copper extraction (%) (vertical axis) against days under leach (horizontal axis);

FIG. 7 is a plot of cobalt extraction (%) (vertical axis) against days under leach (horizontal axis);

FIG. 8 is a table indexing iron dosage (g/L) against feed ORP (mV), effluent ORP (g/L), Fe³⁺ in feed (g/L), Fe³⁺ in effluent (g/L), Cu in feed (g/L), and Cu in effluent (g/L);

FIG. 9 is a table indexing test ID against index time (min), feed flow rate (L/hr), feed pH, Co in feed (g/L), Co in effluent (g/L), Co strip flow rate (L/hr), and Co recovery in PLS (%);

FIG. 10 is a table indexing test ID against MgO addition state, temperature, initial pH, final pH, and Co recovery to MHP (%);

FIG. 11 is a table indexing column identifier against objective, treatment, pyrite coating ratio (%), actual copper extraction (%), theoretical copper extraction (%), difference (%), actual copper extraction (%), theoretical copper extraction (%), and difference (%);

FIG. 12 is a pot of copper extraction (%) against days for a bioleach of ore with 1.5% Fe₂S—copper;

FIG. 13 is a pot of copper extraction (%) against days for a bioleach of ore with 2.5% Fe₂S—copper;

FIG. 14 is a pot of copper extraction (%) against days for a bioleach of ore with 1.5% Fe₂S (MSD)—copper;

FIG. 15 is a pot of copper extraction (%) against days for a bioleach of ore with 1.5% Fe₂S—cobalt;

FIG. 16 is a pot of copper extraction (%) against days for a bioleach of ore with 2.5% Fe₂S—cobalt;

FIG. 17 is a pot of copper extraction (%) against days for a bioleach of ore with 1.5% Fe₂S (MSD)—cobalt;

FIG. 18 is a pot of copper extraction (%) against days under leach for a bioleach of ore-copper;

FIG. 19 is a pot of copper extraction (%) against days under leach for a bioleach of pyrite-copper;

FIG. 20 is a pot of copper extraction (%) against days under leach for a bioleach of ore with 1.5% Fe₂S-copper;

FIG. 21 is a pot of copper extraction (%) against days under leach for a bioleach of ore-cobalt;

FIG. 22 is a pot of copper extraction (%) against days under leach for a bioleach of pyrite-cobalt;

FIG. 23 is a pot of copper extraction (%) against days under leach for a bioleach of ore with 1.5% Fe₂S-cobalt;

FIG. 24 is a flow chart of a solvent extraction circuit in accordance with an embodiment of the disclosure; and

FIGS. 25A-C collectively present a table providing pilot plant results for an embodiment of the present disclosure.

### DETAILED DESCRIPTION

In some embodiments, the present disclosure is directed to a process for recovering copper and cobalt from a copper and cobalt-containing sulfidic ores and concentrates, particularly relatively low grade cobalt bearing sulfide ores and concentrates, using an associated non-stirred bioreactor (e.g., heap) primarily dedicated to copper extraction. The process is particularly applicable to recovery of copper from mixed sulfide-oxide ores in which copper is present as both oxide minerals (e.g., malachite, azurite, chrysocolla, and cuprite among others) and sulfidic minerals (e.g., chalcocite, chalcopyrite, digenite, enargite, and bornite, among others).

Embodiments of the process for recovering copper and cobalt from sulfide ores and concentrates include one or more of the following aspects:
The use of a stirred or non-stirred bioreactor to leach copper and cobalt from a copper and cobalt-containing pyrite sulfide flotation concentrate recovered from a copper flotation tailings stream, with bio-oxidation or other type of oxidation (e.g., hypochlorite, nitrate, chloride, and/or ferric iron as the oxidant) of the sulfide content (which is controlled by managing aeration and irrigation rates) being used to generate heat, thereby increasing copper and cobalt leach kinetics and offsetting acid demands for the process caused by the presence of copper oxides in the heap;
The use of solvent extraction (“SX”) to recover copper from the heap pregnant leach solution (“PLS”) (to avoid interference with downstream cobalt recovery by ion exchange (“IX”)) and a controlled bleed rate from the copper-barren SX raffinate (from copper recovery) (which bleed rate typically ranges from about 5% to about 25% of the SX raffinate flow) to provide a bleed solution having a sufficiently high cobalt tenor or concentration for more efficient operation of the cobalt recovery circuit;
The use of a split SX circuit to reduce cobalt solution losses to a run of mine dump leach;
The use of multiple stages for cobalt recovery from the bleed stream, such stages including a series of purification stages (with a first purification stage to convert or remove iron sulfates and copper such as by iron cementation or lime precipitation, a second purification stage to remove nickel, an optional third purification stage to remove zinc, and a fourth purification stage to remove the aluminum and residual iron by oxidation and precipitation) to increase the recovery in a cobalt concentration stage (e.g., by IX) and/or precipitation stage (e.g., by addition of a precipitant such as MgO or other alkaline earth metal oxide) and purity of the cobalt product; and/or
The use of a series of IX columns to create a high grade cobalt solution for cobalt recovery in which the cobalt loaded eluant is enhanced in grade by recycling a portion of the eluant (typically comprising at least about 2 g/L cobalt and more typically from about 1 to about 5 g/L cobalt along with dissolved zinc and nickel) back to the cobalt strip phase of IX coupled with recycling the cobalt barren waste solution (which typically comprises no more than about 0.05 g/L cobalt) back to the heap leach to act as a rinse to remove the entrained aqueous cobalt from the heap leach. The cobalt barren solution, alternatively, can be combined with the cobalt-free make-up water to increase the volume available for rinsing of the non-stirred bioreactor (e.g., heap).

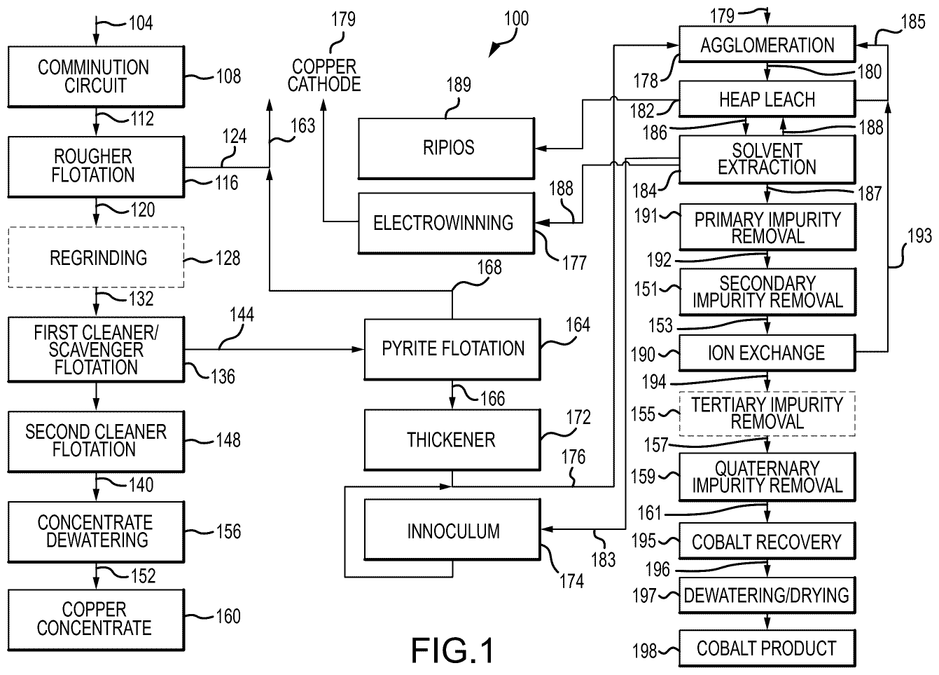

An exemplary process in accordance with the present disclosure is shown in FIG. 1.

Referring to FIG. 1, a feed material 104 comprises predominantly sulfides but, as noted, can include oxides and precious metals including gold and silver. The copper content of the feed material occurs predominantly as copper-containing sulfidic minerals, such as chalcopyrite, bornite, chalcocite, covellite, tetrahedrite, tennantite, enargite, and digenite but can include smaller amounts of copper oxide minerals, such as malachite, azurite, cuprite, tenorite, and chrysocolla, among others. The feed material further includes iron sulfides, typically in the form of pyrite, pyrrhotite, and arsenopyrite, cobalt iron sulfides in the form of cobaltite, linnaeite, carrollite and/or siegenite, nickel iron sulfides in the form of pyrrhotite, millerite, pentlandite, heazlewoodite, polydymite, and/or Vaesite, cobalt sulfides in the form of cattierite, and zinc iron sulfides and zinc sulfides typically in the form of sphalerite and wurtzite as well as other non-sulfidic materials such as silica. The feed material may further contain nickel iron sulfides and aluminum sulfides, among others. Some feed materials include aluminum-containing silicate minerals, such as pyrophyllite, which is a hydrated aluminum silicate mineral.

The feed material 104 is comminuted in a comminution circuit 108 to form a comminuted feed material 112. The comminuted feed material 112 typically has a P₈₀ size typically ranging from about 150 to about 350 microns and more typically ranging from about 200 to about 300 microns. The comminution circuit can be a multi-staged, open or closed, communication circuit(s) comprising one or more crushers (e.g., jaw crushers, cone crushers, impact crushers, roll crushers, and gyratory crushers) and grinding mills (e.g., ball mills, rod mills, semi-autogenous grinding (SAG) mills, tower mills, vertical shaft impactors, and stirred mills).

The comminuted feed material 112 is subjected to rougher flotation 116 to produce a rougher failings fraction 124 and rougher concentrate 120, which may optionally be reground, then subjected to cleaner flotation to produce a cleaner concentrate comprising most of the copper content of the feed material. In a typical implementation, the rougher flotation stage occurs at a typical pH of no more than about pH 10.5 and more typically of no more than about pH 9.5 to facilitate pyrite flotation and form a rougher concentrate typically comprising most and more typically at least about 65% of the sulfidic minerals in the feed material. The rougher concentrate 120 comprises not only typically most and more typically at least about 75% of the copper-containing sulfidic minerals but also most and more typically at least about 75% of the iron sulfides, cobalt iron sulfides, nickel-iron sulfides, aluminum sulfides, and zinc iron sulfides in the feed material 104.

The rougher concentrate 120 is commonly reground 128 to a Pao size ranging from about 25 to about 100 microns and more typically from about 25 to about 75 microns to form a reground concentrate 132 and then subjected to a first cleaner/scavenger flotation stage 136 (comprising a first set of cleaner flotation cells that discharge into a second set of scavenger flotation cells) to form a tailings fraction 144 and first cleaner/scavenger concentrate 140. Cleaner/scavenger flotation typically occurs at a pH of least about pH 10.5 to depress pyrite flotation and produce the first cleaner/scavenger concentrate 140 comprising most and more typically at least about 75% of the copper-containing sulfidic minerals in the rougher concentrate 120 and the first cleaner/scavenger tailings fraction 144 comprising most and more typically at least about 75% of the cobalt, nickel, aluminum, and zinc and pyrite, pyrrhotite, and arsenopyrite along with a small amount of the copper (typically in the form of chalcopyrite, bornite, and covellite) and precious metals content of the rougher concentrate 120. The regrinding stage 128 is mainly intended to liberate cobalt iron sulfide containing species rather than those containing copper (e.g., copper-containing sulfidic and oxidic minerals). This is demonstrated by bioleaching testing data whereby cobalt recoveries as high as +90% can be obtained versus less than 50% for copper. In some configurations, the first cleaner/scavenger concentrate 140 is at a high enough copper grade to convert into a copper matte by smelting. In other configurations, the first cleaner/scavenger concentrate is subjected to second cleaner flotation 148 to form a second cleaner concentrate 152 comprising most of the copper content of the rougher concentrate 120. The second cleaner concentrate 152 is dewatered 156 in a concentrate thickener to provide a high grade copper concentrate 160 for further processing.

The first cleaner/scavenger tailings 144 are subjected to a further pyrite flotation stage 164 in which the first cleaner/scavenger tailings 144 are upgraded at a pH typically of no more than about pH 10 and more typically no more than about pH 9.5 to facilitate pyrite flotation and form an upgraded flotation concentrate 166 and tailings fraction 168. The upgraded flotation concentrate 166 contains most of the sulfide content of the first cleaner/scavenger tailings 144, including most of the copper-containing sulfidic minerals, cobalt iron sulfides, nickel iron sulfides, aluminum sulfide, and zinc iron sulfides and pyrite, pyrrhotite, and arsenopyrite. Typically, the upgraded flotation concentrate 166 comprises at last about 50 wt. %, more typically at least about 75 wt. % sulfides and more typically at least about 85 wt. % sulfides, with typically at least about 65%, more typically at least about 75% and more typically at least about 85% of the sulfides being pyritic iron sulfide. Stated differently, the flotation concentrate 166 typically comprises from about 40 to about 95 wt. % pyrite (e.g., pyrite, pyrrhotite, and arsenopyrite, etc.) and, in some applications, from about 0.1 to about 2.5 wt. % and more typically from about 0.3 to about 1 wt. % cobalt iron sulfides with the balance primarily composed of copper-containing sulfidic minerals, nickel iron sulfides, aluminum sulfides, and zinc iron sulfides. The rougher tailings 124 and pyrite flotation tailings 168 are combined to form a combined tailings fraction 163 and dewatered in a tailings thickener (not shown) for water recycle and tailings storage and disposal.

The various flotation stages 116, 136, 148, and 164) typically use a xanthate collector and pH control (in the absence of the addition of a reagent that depresses pyrite flotation or that activates pyrite flotation) to depress and enable pyrite flotation. Lime and sulfuric acid are used for pH control during the various flotation stages and throughout the various stages of the process. In addition to the collector, a suitable frother is employed. Relative to the cleaner tailings, typical Cu, Co, Ni, and Zn iron sulfide recoveries in the pyrite flotation concentrate, individually and collectively, are in the range of about 85-90%. Pneumatic flotation cells can substantially maximize concentrate grade and recovery. Column flotation cleaner cells can be particularly effective at giving a higher Cu and Co grade in the concentrate.

The upgraded flotation concentrate 166, comprising most of the sulfide content of the cleaner tailings, is dewatered in a thickener 172, combined with raffinate 183 from the solvent extraction circuit 184, sulfuric acid 185 from the heap leach 182, and a mixed inoculum 174 and the inoculant mixture 176 (which typically comprises more than about 60 vol. % solids) agglomerated 178 in an agglomeration drum into agglomerates 180 optionally in the presence of a suitable binding agent to ensure intimate and uniform mixing and rapid kickoff of heap bio-oxidation, and added to a non-stirred bioreactor or heap (such as a dynamic leach pad or DLP) comprising a series of leach cells. The non-stirred bioreactor is typically formed by stacking coated coarse particulates or agglomerates 178 into a heap or placing the coated coarse particulates into a tank so that the void volume of the reactor is greater than or equal to about 25%.

While not wishing to be bound by any theory, there are two primary leaching reactions in the heap leach 182. First, pyrite is bio-oxidized to form sulfuric acid and ferric sulfate. Second, chalcopyrite is oxidized by ferrous sulfate to form copper sulfate and ferrous sulfate. Bacteria catalyzes the oxidation of the resulting ferrous sulfate by sulfuric acid and oxygen back to ferric sulfate. The sulfuric acid formed by pyrite oxidation is typically consumed in the heap leach by the presence of carbonate and other acid consuming minerals. This pyrite-generated acid greatly reduces the sulfuric acid consumption of the heap leach process which typically ranges from about 30 to 70 kg per tonne.

In one embodiment, the agglomerates 178 include not only the upgraded flotation concentrate as the finer sized particulates but also copper oxide-containing material 179, such as selectively mined copper oxide ore or concentrate, as the coarser sized particulates. Typically, an amount of mixed inoculum 174 used in agglomeration ranges from about 1 to about 2% wt/wt of mixed inoculum 174 to the combined upgraded flotation concentrate 164 and copper oxide-containing material 179. The copper oxide-containing material 179 is typically crushed to a P₈₀ size ranging from about 7.5 to about 25 mm. A portion of the oxide ore is sulfidic, which is typical in most oxide copper heap leaches, and the addition of bio-oxidation can improve the copper extraction from this portion of the ore by generating ferric sulfate and acid from the pyrite concentrate, which offsets the ore acid consumption. Heat generated by the oxidation of the pyrite can improve leach kinetics and cobalt/copper extraction. The sulfuric acid solution produced as a byproduct of pyrite oxidation will also typically contain a high concentration of ferric ions. This also makes it an effective lixiviant for copper-bearing sulfidic minerals such as chalcocite. The ferric iron in the acid solution chemically oxidizes the copper-bearing sulfidic minerals to cause their dissolution. Further, the addition of pyrite generates acid that offsets the acid demand of any oxide copper or other acid-consuming reactions in the heap leach 182. The intimate association of the pyrite with the copper oxide ore or concentrate enhances the acid delivery and increases the overall extraction of such copper oxides. The primary sulfides associated with copper oxide ore are not leached to any great extent in a sulfuric acid (non-bio) heap leach (<10%); however, the conversion of the heap leach to a bioheap leach via the addition of air, nutrients and microbes enables the oxidation of those sulfidic minerals.

Bio-oxidation can be effected by any acidophilic, autotrophic bacteria that biooxidizes sulfide minerals (e.g., pyrite, copper-bearing sulfidic minerals, and cobalt iron sulfide minerals) in the presence of air. For example, acidophilic, autotrophic bacteria such as Acidithiobacillus ferrooxidans, Acidithiobacillus thiooxidans, Thiobacillus ferrooxidans; Thiobacillus thiooxidans; Thiobacillus organoparus; Thiobacillus acidophilus; Leptospirillum ferrooxidans; Sulfobacillus thermosulfidooxidans; Sulfolobus acidocaldarius; Sulfolobus BC; Sulfolobus solfataricus and Acidianus brierleyi can be used to biooxidize sulfidic minerals. The bacteria and associated nutrients may not only be included in the agglomerates themselves when formed but also in solution applied to the heap through a sprinkler or other irrigation system.

Inoculum 174 is generated in a separate circuit as shown. A bleed from the raffinate stream 183 is passed through a heated and aerated tank (not shown) to heat the bleed to a temperature of from about 20 to about 30° C. Nutrients are added to promote cell growth. Nitrogen, potassium and phosphorous (N, P, K) nutrients added as sulfates are the typical requirements. In one process configuration, the nutrients are added as ammonium sulfate (for N), potassium phosphate (for K and P), and ammonium phosphate (for N and P). An initial tank, with a short retention time (about 12 to about 24 hours) allows the nutrient addition and the heating of the inoculum to the ideal temperature for growth (typically a temperature ranging from about 20 to about 75° C.). The tank feeds an inoculum pond equipped with aeration with a longer retention time (about 3 to about 6 days). The tank and pond typically maintain a dissolved oxygen content ranging from about 1 to about 10 ppm and more typically from about 2 to about 5 ppm. A resulting microbe population exceeding 10⁶ cells per milliliter is typical. This inoculum is employed in the agglomeration circuit 178, ensuring that the microbes are well distributed in the agglomerates. To ensure rapid kick off of the bio-oxidation, a targeted quantity of inoculum applied per tonne of ore is typically at least about 1.5% wt inoculum to wt of ore. As will be appreciated, there is a tradeoff between adding more inoculum and the cost required to produce the inoculum. A rapid start of the bio-oxidation can be important since a dynamic pad has a fixed and limited retention time.

Once the reactor is inoculated with an appropriate microorganism (e.g., through agglomeration and heap irrigation by application of a leach solution comprising fresh microorganism, acid, and nutrients), conditions in the heap such as pH, temperature, nutrient supply, and moisture content within the reactor should be monitored and maintained throughout the biotreatment so as to promote the growth of the microorganism to the fullest extent possible and substantially optimize leaching kinetics and reduce heap residence times. The amount of fine concentrate that can be added to a crushed heap leach is limited based on the permeability and potential fines migration. Heap permeability should be sufficient to support a lixiviant irrigation rate of about 5 to about 20 liters per hour per m² and more typically from about 7.5 to about 12 liters per hour per m². The coating ratio (CR)—the weight of coarser sized particulates having a P₈₀ size ranging typically from about 7.5 to about 25 mm and more typically from about 10 to about 15 mm (e.g., the crushed selectively mined copper oxide ore) to finer sized particulates having a P₈₀ size ranging from about 25 to about 100 micrometers and more typically from about 35 to about 75 micrometers (e.g., the upgraded flotation concentrate) can be very important in maintaining high levels of heap permeability. Typically, the CR ranges from about 5:1 to about 10:1. Too many fines from the concentrate can reduce the heap permeability and cause solution and air flow issues as well as result in the migration of fine material with the irrigation solution to the bottom of the heap plugging the aeration system and drain rock. As will be appreciated, higher ratios can be employed depending on the application.

Air flow into the heap is provided by a series of stringer pipes placed below the heap to provide oxygen for higher rates of biological oxidation of the sulfidic minerals. The air is distributed from the stringer pipes by a series of calibrated orifices that provide substantially uniform air distribution across the heap. As flow and pressures decrease from the main header, the orifices have to change size to provide an equal amount of air. In some embodiments, the orifice size is fixed and the airflow is varied by automatic damper valves coupled with pulsing air flow through the heap to deliver the required changing air quantities while maintaining equal air distribution. By using a constant feed pressure or flow rate, pulsed air flows, and variable orifice diameters using damper valves along the pipe length, a desirable air distribution along the length of the stringer pipes can be maintained in the heap.

The heap is divided into lengthwise panels and crosswise cells to maximize temperature control. Air and irrigation flows can be controlled for any given cell. The number of cells is a tradeoff between maximizing control and the cost of piping and instruments.

Air flow should not decrease below the minimum required to sustain biological activity; this can be measured by an integrated oxygen measurement device placed on top of the heap or a portable measurement system, in each controllable cell. The air flow rates through the heap are typically in the range of from about 0.25 m³/hr/m² to about 1 m³/hr/m² and more typically from about 0.50 m³/hr/m² to about 0.9 m³/hr/m².

Pyrite oxidation supplies thermal energy to the heap leach, thereby allowing for an increased operating temperature. Elevated temperatures can improve bioleaching. The optimal temperature is a function of the inoculum microbes. The temperature within the heap is maintained typically from about 20 to about 75° C., more typically from about 25 to about 70° C., and more typically from about 25 to about 50° C. (or in the mesophilic range as opposed to the thermophilic range).

To maintain the heap temperature within the desired range, the amount and rate of air and leach solution flows are balanced in terms of heat removal to allow for advection control which reduces heat loss and maximizes the heap temperature. To effectively control the temperature in a heap leach system, there are typically four distinct phases of operation that must be recognized. The first phase involves pH adjustment. The pH should first be adjusted to a level suitable for the microbes-typically from about pH 1 to about pH 3 and more typically between about pH 1 to about pH 2. The second phase involves boot-strapping the temperature by minimizing the rates of air flow and irrigation flow to the heap. Air tends to remove heat from the heap as it becomes humidified and increases in temperature. Similarly, the irrigation solution will increase in temperature and exit the system with additional energy. It can be important to balance the heat flows of these two streams. Incoming air at the bottom of the heap becomes warmed and humidified by contacting the exiting solution. Incoming solution at the top of the heap becomes warmed by passing through the uprising air stream. In reflux control, warm humid air rising out of the heap will condense at the heap surface as it contacts the cooler ambient environment. This returns heat to the heap. The third phase is to maintain maximum temperature control. Maintaining air and solution flows to control the maximum heap temperature prevents thermal termination of the microbe population. The fourth phase requires heat maintenance. At the end of the heap leach cycle, the energy available from sulfide oxidation decreases and accordingly the air and solution rates should be reduced to maintain the heap temperature for as long as possible.

In some embodiments, water is added directly through the heap (e.g., DLP) as an irrigation/wash stream instead of adding it to the raffinate pond or other location to reduce aqueous losses of cobalt. A rinse pond can be used to capture and make use of all the low cobalt streams (MHP effluent, IX effluent, etc.) for rinsing including fresh water.

While the present disclosure is directly primarily to a non-stirred bioreactor or heap leach, it is to be understood that a stirred vat bioleach reactor may be alternatively employed. Compared to a non-stirred bioreactor, leach conditions can be easier to control in a stirred vat bioleach reactor.

The pregnant leach solution 186 or PLS from the heap is treated via solvent extraction or SX 184. The SX circuit 184 is configured to minimize the copper grade in the raffinate 187 as it interferes with the downstream cobalt recovery process (e.g., by ion exchange). Typically, at least about 75%, more typically at least about 85%, and more typically at least about 95% of the copper in the PLS 186 is separated in the copper-loaded eluant 188 and typically no more than about 25%, more typically no more than about 15% and even more typically no more than about 5% of the cobalt, zinc and/or nickel is in the copper-loaded eluant 188, with the balance being in the copper barren raffinate. In some embodiments, the SX metal extraction organic reagent can be aldoxime, though other reagents such as ketoxime or another oxime could also be used. Sulfuric acid at a concentration of about 150 g/L to about 200 g/L or lean electrolyte (e.g., containing about 35 g/L copper) is typically used as the eluant. As will be appreciated, other techniques can be used to separate copper from cobalt, zinc and nickel including ion exchange using an ion exchange resin having a high affinity for copper, such as a hydroxypropylpicolylamine functionalized resin, a chelating resin with high affinity for copper at low pH (e.g., between about pH 3 to about pH 3.5) that can be stripped using strong acid solutions, and other similar resins. The copper loaded eluant 188 is processed in an electrowinning circuit 177 to produce a copper cathode product 179.

While a first portion 189 of the raffinate is recycled to the heap leach as an irrigation solution and in agglomerates as noted above, a second portion 187 of the raffinate from the SX circuit 184 is bled to a cobalt recovery circuit—this bleed rate is controlled to maximize overall cobalt recovery by allowing for increased cobalt grades in the copper raffinate and/or reduce the capacity and capital cost of the cobalt recovery circuit while still providing sufficient barren solution to wash completely the copper ripios 189 or spent heap leach ore. The bleed of the second portion 187 can allow the cobalt tenor to be increased to a grade high enough to be more easily treated in the downstream cobalt recovery processes. In a typical application, the cobalt solution grade of the second portion 187 can be increased and maintained in the multi-gram per liter range (typically from about 0.5 to about 10 g/L, more typically from about 1 to about 7.5 g/L, more typically at least about 2 g/L, and more typically from about 2 to about 5 g/L). Typically, the second portion 187 of the raffinate constitutes between about 5 to about 15 vol. % of the raffinate treated by the SX circuit 184. As will be appreciated, the SX reagents in the SX circuit 184 remove little, if any, of the cobalt in the PLS 186. Downstream cobalt recovery is accomplished by a series of purification stages followed by a concentration and precipitation stage.

While an elevated cobalt tenor or concentration can have the advantage of improving the downstream cobalt recovery process, it can also lead to increased cobalt aqueous losses in the heap. In a DLP heap leach, the leached material (ripios 189) is removed from the pad and placed in a waste storage facility. The final moisture content of this material will vary but typically ranges from about 5 to about 15%. In a copper leach system, the residual copper in solution is rinsed out of the heap using the low copper tenor raffinate as the final irrigation solution. In the case of the cobalt system, the raffinate has a high cobalt tenor which precludes using this stream to rinse the residual aqueous cobalt from the ripios 189. The way around this is to apply a final water rinse to the heap. Instead of adding makeup water to the raffinate pond, it is typically added directly to the heap as a rinse stream. In this manner, the cobalt aqueous solution losses from recycling the cobalt-containing raffinate to the heap can be reduced from up to 25% to no more than about 0.5% using this method.

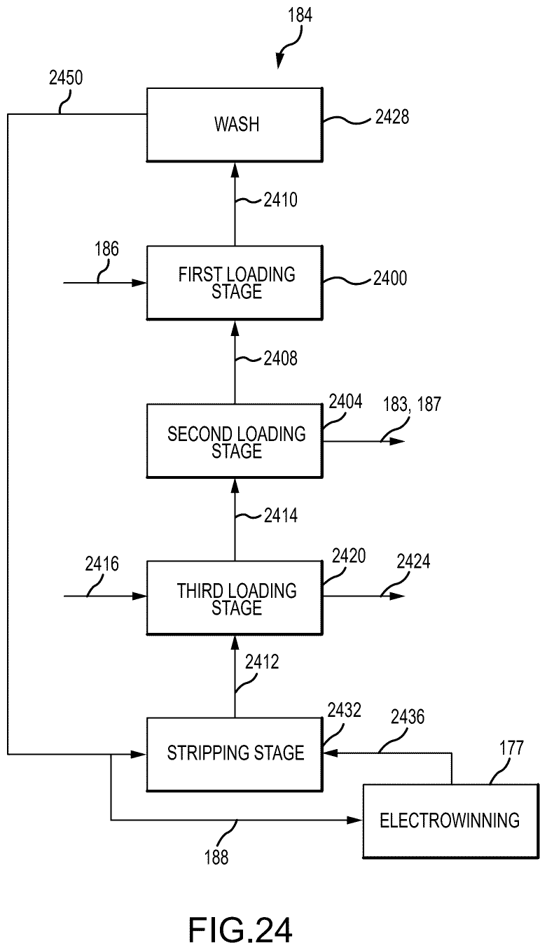

In an embodiment shown in FIG. 24, the SX circuit 184 is separated into two separate first and second treatment lines in a process configuration comprising a dump leach for leaching run-of-mine copper oxide and cobalt-containing material and a heap leach as described above to reduce cobalt losses in the heap from raffinate recycle. As in the case of the heap leach, the dump leach is irrigated with a dilute sulfuric acid solution first in a strong acid cure followed by a leach cycle using either an intermediate leach solution (e.g., a solution that has already leached metals in the heap leach but is not yet at the desired PLS concentration or grade and is therefore to be recycled to the heap to leach more metal) or raffinate. Valuable metal-containing material, whether ore or concentrate, can be delivered to one of the leaching operations based on copper and carbonate grades with higher copper and lower carbonate grades being sent to the heap leach and the balance to the dump leach. A typical cut-off grade typically ranges from about 0.1 to about 0.3% Cu depending on market pricing for copper and sulfuric acid.

In this embodiment, the SX circuit 184 can be configured to have countercurrent flows of SX reagent or extractant and pregnant solution flows. Stated differently, the pregnant leach solution 186 from the heap leach 182 would pass through first and second loading stages 2400 and 2404 to load copper onto the reagent and form the raffinate 183 and 187, and the pregnant leach solution 2416 from the dump leach flows through the third loading stage 2420 to form raffinate 2424. The barren reagent 2412, meanwhile, flows counter-currently from the third loading stage 2420 where it is loaded with copper from the pregnant leach solution 2416 to form first loaded reagent 2414, to the second and first loading stages 2404 and 2400 where it is loaded with copper from the pregnant leach solution 186 to form loaded reagents 2408 and 2410, to the wash stage 2428 where it is washed of residual solution to form washed loaded resin 2450 and finally to the stripping stage 2432 where the loaded copper is stripped to form barren reagent 2412 and copper loaded eluant 188 that is passed through the electrowinning system 177 with the barren electrolyte 2436 being returned to the stripping stage as the stripping solution. The use of different loading stages for the pregnant leach solutions from the heap leach and dump leach, while using common wash and strip stages, would yield a common copper loaded eluant 188 but different raffinate streams, one of which proceeds to iron removal and copper cementation as described below and the other of which reports to a raffinate pond.

Cobalt losses can result when the dump leach and heap leach pregnant leach solutions are comingled and treated in a common SX loading stage. This configuration can present a problem for the control of the cobalt losses. If high cobalt raffinate is used to irrigate the existing dump leach, the cobalt will be trapped in the residual waste material. A water rinse is not possible because of the size of the dumps and the timing of ongoing ore placement. The cobalt left behind in the residue would be lost until the dumps were completed and a water rinse could be applied. To address this issue, the heap and dump leach solutions are treated separately in the first and second and third loading stages, respectively. That is, the raffinate from the first and second loading stages is not commingled with raffinate from the third loading stage and raffinate from the third loading stage is not commingled with raffinate from the first and second loading stages to reduce cobalt losses to the dumps. In other words, the raffinate in the first and second loading stages is recycled to the heap leach and not to the dump leach and the raffinate in the third loading stage is recycled to the dump leach and not to the heap leach. The separation of the SX circuit into first/second and third separate loading stages can provide a lower overall raffinate copper grade, thereby improving (or decreasing) copper losses to the tailings. In one configuration, each of the first/second and third loading stages comprises one or more mixers/settlers in series to separate the copper loaded reagent from the copper-barren solution 187 but the first/second and third load stages use a common strip mixer/settler to remove the organic reagent from the copper loaded eluant 188.

The second portion 187 of the raffinate typically comprises at least about 1 g/L, more typically at least about 1.25 g/L, a more typically at least about 1.5 g/L, and more typically from about 1.5 to about 5 g/L cobalt; at least about 5 g/L, more typically at least about 10 g/L and more typically from about 10 to about 35 g/L ferric iron; at least about 1 g/L, more typically at least about 2.5 g/L, and more typically from about 2.5 to about 25 g/L ferrous iron; at least about 5 ppm, more typically at least about 10 ppm, more typically at least about 15 ppm, and more typically from about 20 to about 150 ppm nickel; at least about 50 ppm, more typically at least about 75 ppm, more typically at least about 100 ppm and more typically from about 100 to about 750 ppm copper; at least about 1 ppm, more typically at least about 10 ppm, and more typically from about 250 ppm zinc; at least about 1 ppm, more typically at least about 5 ppm, and more typically from about 10 to about 50 ppm aluminum, and at least about 10 ppm and more typically from about 25 to about 250 ppm organic SX extractant. The second portion typically has a pH of no more than about pH 5, more typically no more than about pH 3.5 and more typically ranges from about pH 1 to about pH 2.5 and comprises from about 0.1 to about 10% wt/wt and more typically from about 0.5 to about 5% wt/wt dissolved solids.

The presence of various elements in the second portion 187 of the raffinate deleterious to cobalt recovery (such as ferric iron and copper) should be minimized prior to cobalt adsorption by an ion exchange (IX) 190 resin. Ferric iron and copper can occupy active sites on the resin reducing its loading capacity and potentially contaminate the final cobalt product. Copper removal 191 by solvent extraction precedes cobalt removal because the ion exchange resin that has a high affinity for cobalt also has a high affinity for copper, leading to contamination of the resin by the copper. In a primary impurity removal stage 191, the ferric sulfate is reduced to ferrous sulfate using metallic iron (e.g., iron powder) (or other form of iron like scrap). Unlike ferric iron, ferrous iron will not adsorb onto the downstream IX resin to contaminate the cobalt recovery circuit. Contact of the second portion 187 of the raffinate with metallic iron in the primary impurity removal stage 191 can also cause the residual copper in the second portion 187 of the raffinate to precipitate as metallic copper to form a copper barren solution 192. The iron powder (or other form of iron like scrap) acts as a reducing agent causing the precipitation of the copper on the iron powder surface and also changes the oxidation state of the iron from ferric to ferrous. As will be appreciated, other techniques can be used to convert ferric iron to ferrous iron.

In some implementations of primary impurity removal stage 191, at least most and more typically at least about 75% of the copper is precipitated and removed from the second portion of the raffinate and at least most and more typically at least about 75% of the ferric iron in the second portion of the raffinate is reduced to ferrous sulfate while at least most and more typically at least about 75% of cobalt, zinc, and nickel remain in a copper barren solution 192. The pH in copper cementation is controlled to reduce the consumption of the metallic iron due to iron powder degradation by free sulfuric acid and minimize evolution of hydrogen gas, typically being raised from an initial pH of no more than about pH 1.5 to a final pH of from about pH 1.8 to about pH 4 and more typically a final pH of from about pH 2 to about pH 4. The vessel in which copper cementation is performed may be aerated by air sparging to strip hydrogen gas from the solution. After residual copper removal, the cobalt-bearing copper barren solution 192 comprises typically no more than about 1 ppm copper and no more than about 100 ppm ferric iron at less than 500 mV (Ag/AgCl). Typically, no more than about 50 g/L, more typically no more than about 25 g/L, and more typically no more than about 15 g/L Fe powder is contacted with the cobalt. A typical concentration range for the metallic Fe ranges from about 1 to about 10 g/L.

As will be appreciated, other methods may be used to remove residual copper and ferric iron from solution. For example, an electrolytic cell may be used to reduce ferric iron to ferrous iron followed by ion exchange to remove at least most of the copper and ferrous iron from solution. In the electrolytic cell, a voltage is applied between an anode (positively charged) and a cathode (negatively charged) that are immersed in an electrolyte solution (which is typically an aqueous sulfuric acid solution) to cause oxidation at the anode and reduction of ferric iron to ferrous iron at the cathode. An ion-exchange membrane may be positioned between the anode and cathode to selectively pass desired ions while blocking passage of others.

Ion exchange separation of copper from the second portion 187 of the raffinate may be performed using a resin having a high affinity for copper but a low affinity for cobalt, such as a resin sold under the tradename LSC485™ and resins with chelating functional groups like bis-picolylamine, iminodiacetate, and sulfonic groups, as well as resins with 8-hydroxyquinoline or piperazine based chelating agents.

Alternatively, the second portion 187 of the raffinate may be contacted with an oxidant, such as air sparging and/or addition of another oxidant such as potassium permanganate, Caro's acid, and hydrogen peroxide, to convert ferrous to ferric iron followed by pH adjustment typically to a pH of at least about pH 5 and more typically to a pH of at least about pH 7 to precipitate at least most of the ferric iron, aluminum and copper from solution.

After the purified cobalt-bearing copper barren solution 192, comprising at least most of the cobalt, nickel and zinc in the cobalt-rich stream is subjected to solid/liquid separation (such as by a clarifier in series with an overflow centrifuge with the clarifier underflow being in the range of 50 to about 80% wt/wt solids and the centrifuge discharge being in the range of about 85 to about 98% wt/wt solids), the separated solution is passed, after a secondary impurity removal stage 151, to the ion exchange or IX system 190, which recovers cobalt from the treated raffinate. The iron treatment solids can be disposed of or sent for further processing to recover the precipitated copper.

The secondary impurity removal stage 151 removes at least most of any SX extractants or other organics and residual suspended solids from the separated solution to form a treated separated solution 153 at least substantially free of entrained organic extractants and suspended solids. As will be appreciated, the organic reagent can degrade the downstream ion exchange resin. Organic removal can be effected by any techniques, including dual media filtration, activated carbon filtration, membrane filtration, and the like coupled with a backwash tank. As will be appreciated, a dual media filter uses two or more different types of media layers to remove suspended solids and other impurities from a solution. Typically, it includes a layer of anthracite coal, a layer of sand, and a layer of garnet. Air may be injected into the separated solution to improve organic separation. Typically, the treated separated solution comprises no more than about 500 ppm, more typically no more than about 250 ppm, and more typically no more than about 25 ppm organic reagent. In some process configurations, this stage precedes the first impurity removal stage.

The treated separated solution 153 is passed to the ion exchange system 190. In one configuration, the ion exchange system 190 is a counter current ion exchange (CCIX). The system comprises a series of IX columns all containing a resin that is suitable for cobalt extraction. The solution passes through a series of columns for cobalt removal. In some process configurations, the IX resin is a chelating resin (e.g., a resin sold under the tradename LSC772™, phosphoric acid resin, bisphenol A (BPA), or a bispicolylamine functionalized ion exchange resin). To maximize cobalt loading on the IX resin, the copper barren solution 192 typically is adjusted to have a pH ranging from about pH 2 to about pH 4. The performance of the IX resin typically deteriorates above pH 4. The cobalt barren solution 193 is combined with the copper raffinate 185 and returned to the heap leach 182. The resin becomes loaded with cobalt and is subsequently stripped with a suitable strip solution (in this case dilute sulfuric acid though any mineral acid may be employed). Typically, the cobalt strip solution is an aqueous solution comprising from about 15 to about 50 g/L and more typically from about 20 to about 30 g/L sulfuric acid. The strip solution (not shown) is at a lower flowrate than the treated separated solution 153 and subsequently contains a much higher cobalt tenor (typically from about 2.5 to about 25 g/L and more typically from about 4 to about 15 g/L). Contacting of the sulfuric acid strip solution with the cobalt-loaded resin not only removes the cobalt in a cobalt loaded eluant 194 but also regenerates the resin CCIX and can significantly reduce resin and solution volumes, provide flexible process conditions, and use multiple adsorption passes (i.e., dump leach versus heap leach and barren versus intermediate solutions) and multiple elution phases.

The series of ion exchange columns in the IX system 190 can adsorb not only at least most of the cobalt but also at least most of the competing ions of nickel, iron (ferric not ferrous) and zinc in the copper barren solution 192. In some process configurations, the ion exchange system 190 addresses the co-loading of cobalt and nickel by separately eluting cobalt and nickel in separate stages using multiple ion exchange columns with a rotating valve assembly that facilities the changing order of the columns during operation from adsorption, backwash of the resin, cobalt stripping from the resin to form a cobalt-loaded eluant and nickel-loaded resin, nickel stripping from the nickel loaded resin to form a nickel-loaded eluant and barren resin and rinsing of the barren resin to remove residual stripping solution before the foregoing stages are sequentially repeated. Typically, the nickel strip solution is an aqueous solution comprising from about 50 to about 200 g/L and more typically from about 75 to about 150 g/L sulfuric acid.

Regardless of the ion exchange system configuration, the cobalt-loaded eluant 194 is typically enhanced in grade by recycling a portion of the cobalt-loaded eluant (not shown) (typically ranging from about 5 to about 35%) back to the cobalt strip phase of the IX system 190. Increasing the grade is beneficial to enhance the subsequent downstream cobalt recovery. As will be appreciated, solvent exchange may alternatively be employed to adsorb cobalt from the treated separated solution 153.

In one process configuration, hydrochloric acid is used to remove adsorbed iron (ferric) from the resin, ammonia hydroxide for copper removal, and sodium hydroxide for residual organic reagent (from solvent extraction) removal. This process configuration can effectively regenerate the resin for the loading stage. These operations are typically performed after the nickel stripping stage and before the rinsing stage.

Additional strip and regeneration stages can be included to remove iron, nickel, zinc and copper.

As will be further appreciated, though ferric iron is reduced to ferrous iron by addition of metallic iron, ferric iron may still be present in the cobalt loaded eluant 194. Although the IX resin used for cobalt is less selective for ferrous iron, there will also be ferrous iron present in the zinc barren raffinate 194 due to the high concentration of total Fe in the copper barren solution 192. During ion exchange 190, the ferric iron and ferrous iron will adsorb onto the IX resin in the first IX stage but pass along with the cobalt in the second IX stage and will therefore be precipitated along with the cobalt in response to the addition of MgO and sodium hydroxide in the cobalt recovery stage 195 (discussed below).

To substantially minimize the content of residual Fe metal hydroxide precipitates in the cobalt precipitates 196, an optional tertiary impurity removal stage 155 may be added after the first IX stage and before the second IX stage of the ion exchange system 190 or after the second IX stage and before cobalt recovery 195 to remove at least most and more typically at least about 75% of the dissolved ferrous and ferric ions. This can be done by modifying the solution pH of the inter-stage raffinate to about pH 1.5 to about pH 3 and either adding an oxygen-containing oxidant, or by adding suitable bacteria for bio-oxidation, to oxidize the ferrous to ferric (because ferrous iron precipitates at low pH), followed by lime or other base addition to raise the pH to cause precipitation of at least most of the ferric ion as ferric hydroxide and residual aluminum as aluminum hydroxide while leaving at least most of the cobalt in solution.

In one configuration of the tertiary impurity removal stage 155, at least most and more typically at least about 75% of residual iron and aluminum are removed from the cobalt loaded eluant 194 before cobalt recovery to form a treated cobalt loaded eluant 157. Tertiary impurity removal converts residual ferrous iron to the ferric form using a bio-oxidation system followed by precipitation of the ferric sulfate and aluminum sulfate by base addition (e.g., lime addition). The bio-oxidation system comprises a plurality of biocolumns in parallel that are packed with a suitable substrate, such as plastic rings or bioballs, that allow the formation of a suitable biofilm and facilitate the intimate contact of the treated separated solution with injected low pressure air. Typical mesophilic bacteria are utilized to inoculate the biocolumns, with the bacteria being sourced from the inoculum 174. The treated separated solution flows downward countercurrently to the incoming air. The air and bacteria oxidize the ferrous iron in ferrous sulfate to ferric iron to improve subsequent iron precipitation. As will be appreciated, an electrolytic cell having reversed polarity relative to the electrolytic cell described previously could alternately be used to convert at least most of the ferrous iron back to ferric iron.

The discharged solution then reports to the metal precipitation stage of tertiary impurity removal. At least most of the iron and aluminum precipitate from the solution at an adjusted solution pH of at least about pH 5 to form a discharged slurry. The discharged slurry reports to a clarifier and the clarifier underflow reports to an overflow centrifuge. Solution from the downstream zinc rinse stage in ion exchange system 190 can be recycled to the discharge slurry upstream of the clarifier to take advantage of the available sulfuric acid. The clarifier underflow is typically in the range of 50 to about 80% wt/wt solids, and the centrifuge discharge is typically in the range of about 85 to about 98% wt/wt solids. A portion of the clarifier underflow can be recirculated to the metal precipitation stage as a seed crystal. The clarifier and centrifuge overflow or treated cobalt loaded eluant 157 reports to an acidification tank (not shown), which acts as a stock tank and acidification system for the downstream zinc removal ion exchange stage. The solution pH in the tank is adjusted to a pH typically of from about pH 2 to about pH 5 and more typically of from about pH 2 to about pH 3.5 using sulfuric acid. The separated solids typically comprise at least most and more typically at least about 75% of the iron and aluminum in the treated separated solution.

The treated cobalt loaded eluant 157 typically comprises at least most and typically at least about 75% of the zinc and cobalt but no more than about 25% and more typically no more than about 15% of the iron, nickel and aluminum in the treated separated solution, typically has a pH ranging from about pH 1 to about pH 3.5 and more typically from about pH 1.5 to about pH 3, and is passed to a quaternary impurity removal stage.

In a quaternary impurity removal stage 159, an ion exchange or IX circuit may be used to separate the zinc and cobalt and provide a zinc barren raffinate 161. The circuit is similar to the ion exchange circuit 190 but typically uses conventional automatic valving to facilitate column indexing among the various adsorption, backwash, strip, and rinse stages. The circuit may use a resin, such as an aminophosphonic acid resin or a resin sold under the tradename LSC790™, that loads at least most of the zinc in the eluant while passing at least most and more typically at least about 75% of the cobalt in a zinc barren raffinate 161 (which typically includes no more than about 15% and more typically no more than about 5% of the zinc and at least most of the cobalt in the SX raffinate). The loaded zinc can be stripped by an H₂SO₄ stripping solution typically comprising from about 75 to about 150 g/L and more typically from about 100 to about 175 g/L H₂SO₄. As in the case of the upstream IX circuit 190, the resin is reconditioned simultaneously with zinc elution. In one configuration, an iron strip stage may be included to remove any buildup of iron on the resin. The strip solution to remove the adsorbed iron typically comprises from about 75 to about 200 g/L and more typically from about 100 to about 150 g/L oxalic acid.

In another process configuration of the quaternary impurity removal stage 159 that can use the ion exchange system 190, at least most of the co-loaded cobalt and zinc is sequentially and separately eluted from the ion exchange resin-loaded nickel using weak and then strong H₂SO₄ solutions, respectively, to provide a cobalt-rich eluant containing at least most of the adsorbed cobalt and a zinc-rich eluant containing at least most of the adsorbed zinc, respectively, while leaving at least most of the nickel loaded on the resin for subsequent elution of the nickel to form a nickel-rich eluant containing at least most of the adsorbed nickel. Nickel can be desorbed from the resin by techniques, including pH reduction by the eluant using a different concentration of sulfuric acid from the cobalt and zinc eluants. Each of the cobalt, zinc and nickel can be recovered from the respective eluant by known techniques. “Weak” sulfuric acid solutions typically comprise between about 2% to about 4% and more typically between about 2.5% to about 3.9% H₂SO₄ while “strong” sulfuric acid solutions typically comprise between about 20% to about 45% and more typically between about 15% to about 40% H₂SO₄. As will be appreciated other acids may be employed. The elution and regeneration can be conducted simultaneously using H₂SO₄ or a separate regeneration stage can be included using the appropriate chemical.

As will be appreciated, solvent exchange may alternatively be employed to adsorb zinc from the cobalt eluant. Any solvent exchange extractant that is selective for zinc may be employed, such as di-2-ethylhexyl phosphoric acid (D2EHPA) or tributyl phosphate (TBP) in a pH range of about pH 2.5 to about pH 3.5 providing a high affinity of the resin for zinc and a low affinity for cobalt.

The zinc barren raffinate or high grade cobalt solution 194, which typically comprises no more than about 10 ppm zinc, no more than about 10 ppm nickel, no more than about 100 ppm aluminum, no more than about 100 ppm iron, and no more than about 1 ppm copper, reports to a cobalt recovery (e.g., mixed hydroxide precipitation) circuit 195 where MgO is added to cause the precipitation of at least most and more typically at least about 75% of the solubilized cobalt as a cobalt hydroxide precipitate 196.

To provide faster reaction kinetics and reduce consumption of MgO in cobalt recovery 195, a two-step precipitation process may be employed. In the first step, MgO is contacted with the zinc barren raffinate 194, which raises the pH of the zinc barren raffinate 194 from a pH ranging from about pH 2 to about pH 2.5 to a pH ranging from about pH 5.5 to about pH 6.5. The amount of MgO added typically ranges from about 100 to about 150% of the stoichiometric ratio based on the concentration of cobalt in the zinc barren raffinate. After a residence time sufficient for some but not all of the MgO to precipitate the cobalt from solution, a hydroxide, such as an alkali metal hydroxide (typically sodium hydroxide), is added in a second step to raise the pH to at least about pH 7.5 and more typically to a pH ranging from about pH 8 to about pH 9 to precipitate the remaining cobalt from solution. The amount of hydroxide added typically ranges from about 75 to about 125% of the stoichiometric ratio based on the concentration of cobalt in the zinc barren raffinate.

The cobalt precipitates 196, which have a high purity, can be separated by any suitable solid/liquid separation technique and dewatered and dried 197 by suitable techniques to provide a high purity cobalt product 198. In one configuration, at least most of the cobalt precipitates are removed by a clarifier in series with an overflow centrifuge with the clarifier underflow being in the range of 50 to about 80% wt/wt solids and the centrifuge discharge being in the range of about 85 to about 98% wt/wt solids. A portion of the clarifier underflow can be recirculated to the cobalt recovery stage as a seed crystal.

As will be appreciated, other techniques can be employed to recover the cobalt from the zinc barren raffinate or high grade cobalt solution 194, including ion exchange or solvent extraction followed by electrowinning of the cobalt from the cobalt loaded eluant. Ion exchange can be performed using a chelating ion exchange resin that selectively binds to cobalt ions and stripped by a sulfuric acid solution as the eluant followed by electrowinning of the cobalt from the eluant. Solvent extraction, by comparison, can be performed using an organic extractant, such as Cyanex 272™, 301™, 302™, and 923™, D2EHPA, Alamine 336™ and 304™, and trioctylamine (TOA). As will appreciated, the electrochemical potential of cobalt is more negative and other metals are more likely to plate first in the same solutions. Additionally, the electrochemical potential of cobalt is close to that of nickel and therefore is difficult to selectively electrowin and zinc can cause cobalt to peel away from the cathode when electrowinning. Accordingly, the cobalt loaded eluant must be substantially free of other metals to provide a high purity cobalt product.

The waste solutions from the circuit that are low in cobalt (including the backwash from the organic removal filters noted above) are recycled back to the heap leach to act as a rinse to remove the entrained aqueous cobalt from the heap leach. As described above, a typical leach cycle for an oxide heap bio-leach is as follows:
1. Leach with intermediate leach solutions (ILS)—which is a medium to low grade copper solution augmented with acid;
2. Leach with raffinate (which is low in copper grade but high in acid content) to rinse any residual copper from the heap-aqueous solution losses are in the range of about 2 to about 5%. In the cobalt system an extra rinse can be added;
3. Rinse with water and waste solutions very low in cobalt to rinse the residual cobalt from the heap-without this step aqueous solution losses exceed about 15% Co because the raffinate is high in cobalt by design; and
4. Copper solutions from the heap are directed as either the ILS for use as described above when the copper grade is medium to low or PLS 186 when the copper grade is higher.

### EXPERIMENTAL

The following examples are provided to illustrate certain embodiments of the disclosure and are not to be construed as limitations on the disclosure, as set forth in the appended claims. All parts and percentages are by weight unless otherwise specified.

Multiple test programs were conducted to evaluate process variables including: flotation testing related to the cleaner scavenger concentrate (CSC) generation, bioleach testing of the CSC with copper oxide ore, laboratory and pilot testing of the counter current ion exchange (CCIX) system, MetSim® modeling of the complete process circuit of FIG. 1, and engineering design of the FIG. 1 flowsheet at a prefeasibility level.

In connection with the evaluation process, a column leach program was conducted to determine the effectiveness of metals leaching with the addition of inoculum to the heap leach system. Seven column tests were conducted with the acid leach being the baseline.

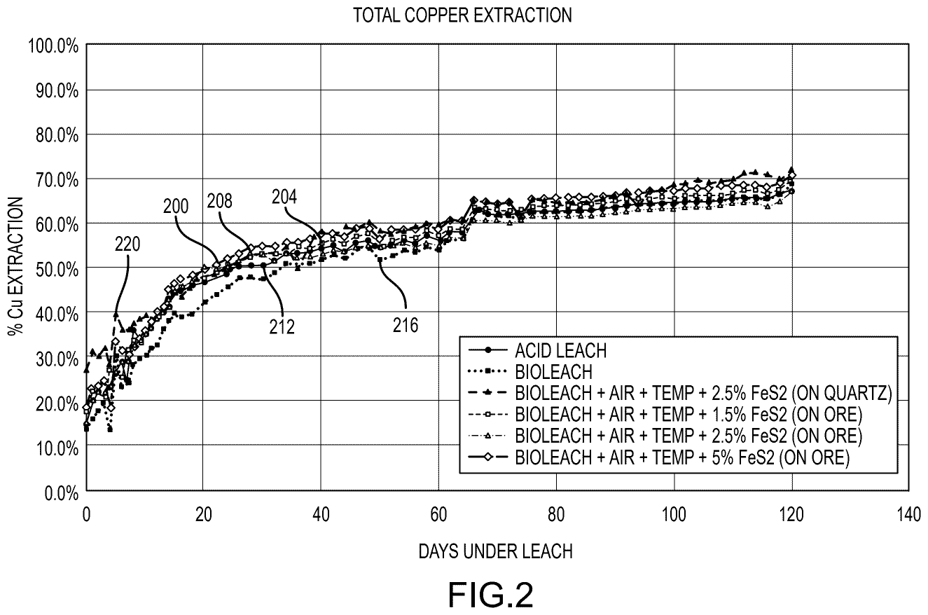

The results of FIG. 2 show that an increase in copper extraction is observed under bioleaching conditions with the curve 200 being for an aerated bioleach in the presence of 5% FeS₂ (on ore), the curve 204 being for an aerated bioleach in the presence of 1.5% FeS₂ (on ore), the curve 208 being for an aerated bioleach in the presence of 2.5% FeS₂ (on ore), the curve 212 being for an acid leach, the curve 216 being for a bioleach, and the curve 220 being for an aerated bioleach in the presence of 2.5% FeS₂ (on quartz). Total copper extraction of the dynamic leach pad (DLP) is typically within a range of from 43 to 59% for approximately 90 days under leach and from 55-60% within a typical leach period (˜110 days). This was likely due to the oxidation of the pyrite concentrate and sulfidic ore.

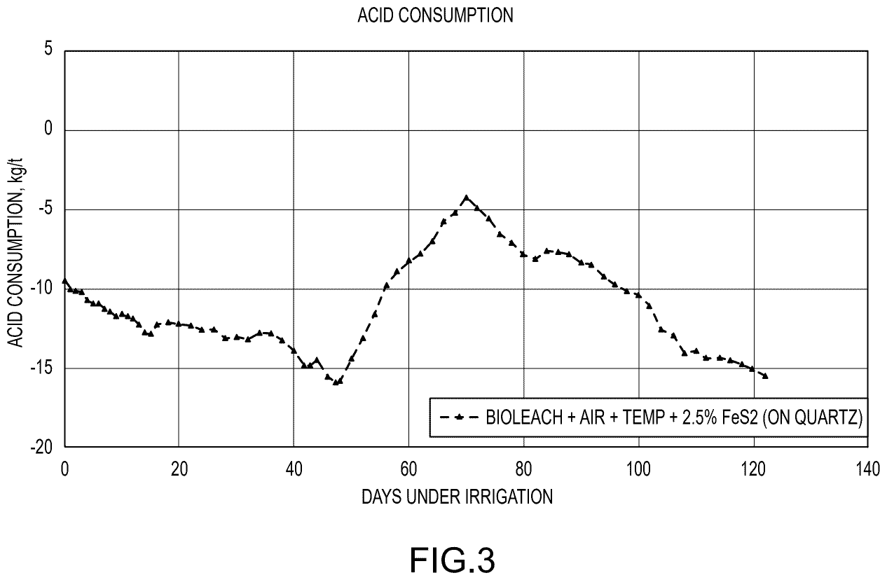

The oxidation of the sulfidic portions also generates acid as shown in FIG. 3.

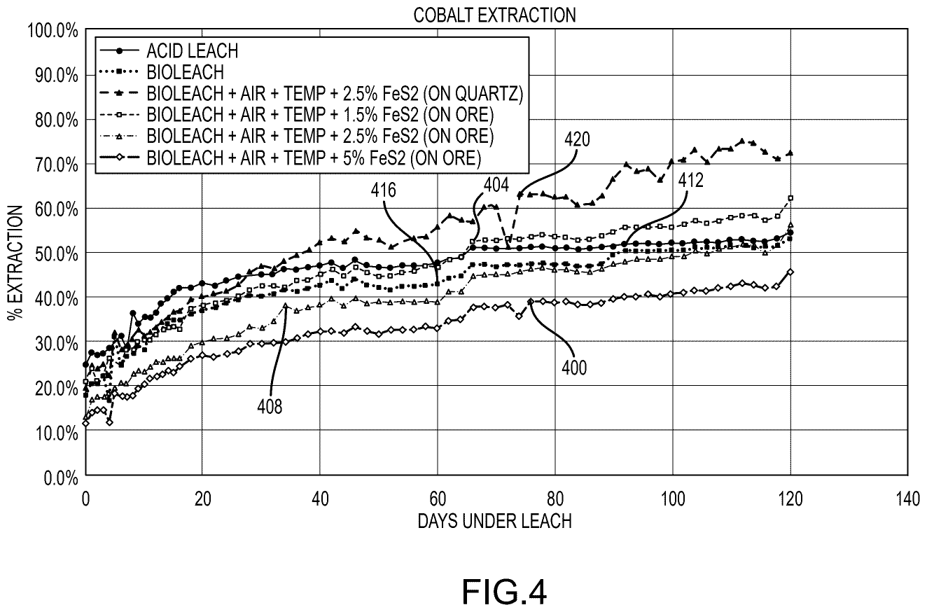

The cobalt extraction of all columns performed are shown in FIG. 4 with the curve 400 being for an aerated bioleach in the presence of 5% FeS₂ (on ore), the curve 404 being for an aerated bioleach in the presence of 1.5% FeS₂ (on ore), the curve 408 being for an aerated bioleach in the presence of 2.5% FeS₂ (on ore), the curve 412 being for an acid leach, the curve 416 being for a bioleach, and the curve 420 being for an aerated bioleach in the presence of 2.5% FeS₂ (on quartz). As can be seen from FIG. 4, cobalt recovery ranged from 40 to 59% (with ore) and was 84% for pyrite only (with quartz) for cobalt leach columns at approximately 90 days under leach.

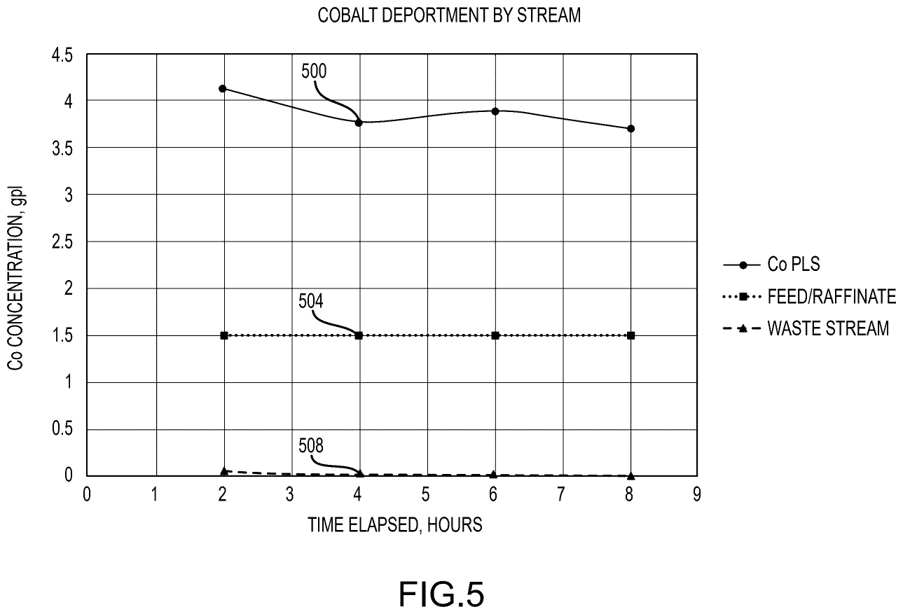

With reference to FIG. 5, ion exchange pilot scale tests were performed with varying parameters such as Co/Ni grade in the raffinate, pH of the feed solution, solution flows, acid strengths, etc., with the curve 500 being for a Co PLS, the curve 504 being for a feed/raffinate, and curve 508 being for a waste stream. The pilot plant has been operational since early 2024 and a set of optimal parameters has been determined. The cobalt recovery to the PLS stream has ranged from 60 to 95% depending on the set of parameters used. As can be seen from FIG. 5, cobalt content of the PLS was much higher than that in the raffinate and both had a significantly higher content than that in the waste stream.

Preliminary test work was initiated for the production of the final cobalt product, including test work on the production of Co(OH)₂ by addition of MgO and/or NaOH. Details of the test work performed to date regarding the recovery of cobalt from sulfidic ores and concentrates is discussed below.

A bioleach column test program was developed to determine the potential uplift in metal recovery from copper oxide ore (containing both oxides and minor sulfides) combined with a sulfide concentrate. The bioleach columns were equipped with aeration and temperature control to simulate the environment within a commercial bioheap leach pad.

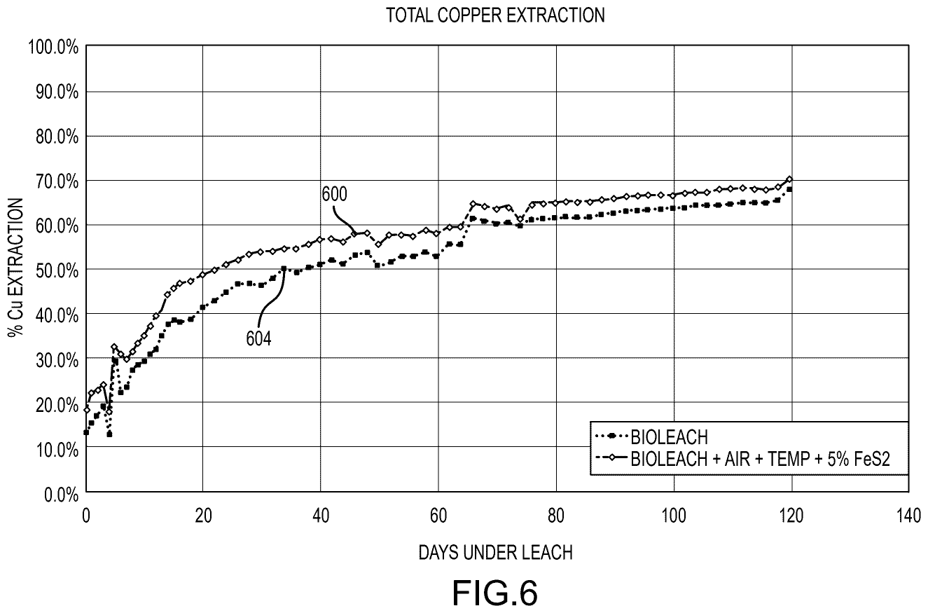

A bioleach column conducted on copper oxide ore alone (without the addition of sulfide concentrate) was performed as a control for the program. A separate bioleach column with ore and the addition of sulfide concentrate was performed to determine the potential increase in metal recovery. The copper recoveries of the two columns are presented in FIG. 6 where curve 600 is for an aerated bioleach in the presence of 5% FeS₂ and the curve 604 is for a bioleach.

The copper extraction of the ore bioleach column achieved a total copper recovery of 67.8% (orange). The bioleach column with the addition of the sulfide concentrate achieved a total copper recovery of 69.9% (green). The total copper extraction of the column tests is greater than that observed in the current commercial acid heap leach pad (55-60% within 110 days).

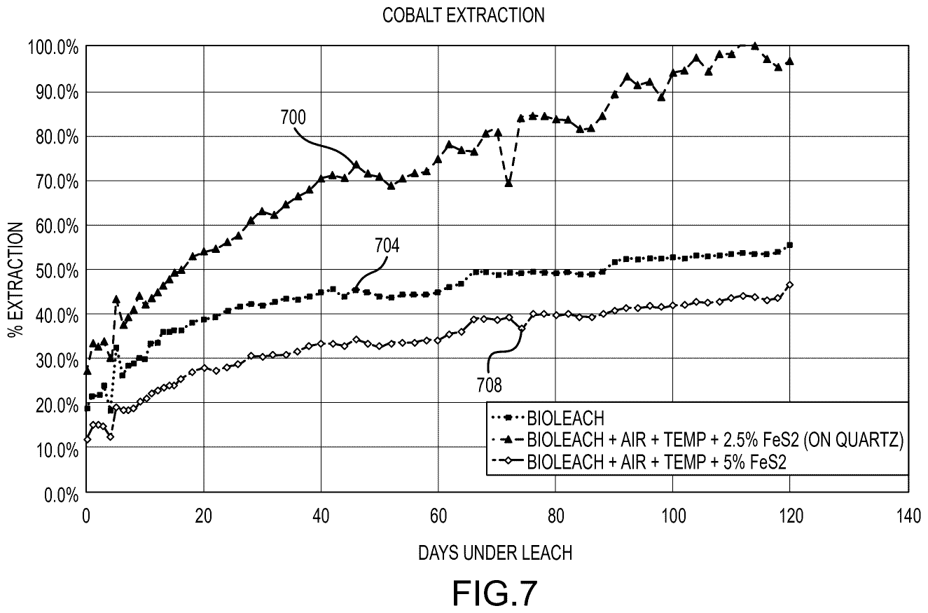

The performance of the cobalt extraction of multiple bioleach columns is presented in FIG. 7 with the curve 700 being for an aerated bioleach in the presence of 2.5% FeS₂ (on quartz), the curve 704 being for a bioleach, and the curve 708 being for an aerated bioleach in the presence of 5% FeS₂. The cobalt extraction of the sulfide concentrate agglomerated on inert quartz is close to 100% (grey). The cobalt extraction of the ore bioleach column achieved 55.1% (orange). A lower cobalt extraction was observed in a column with a higher proportion of concentrate (coating ratio). This result is likely due to the increased coating ratio.

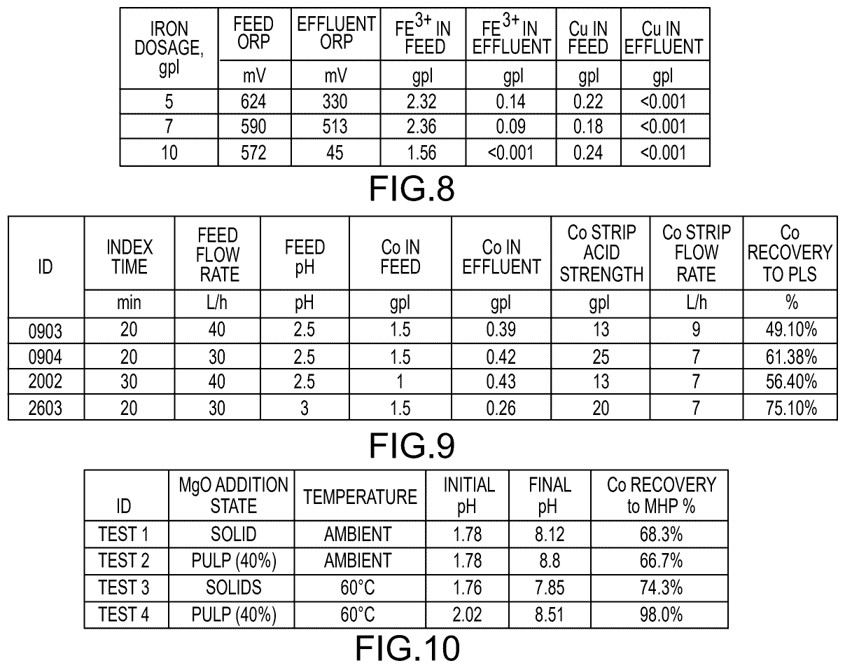

The recovery of cobalt using ion exchange resin requires the removal of copper and also the conversion of ferric sulfate to ferrous sulfate. This has been effected through an iron cementation process. Iron powder additions to the incoming raffinate is performed to remove copper via cementation and to reduce the ferric iron to ferrous iron. This is desired as copper and ferric iron reacts with the resin downstream. The results of cementation test work performed at the pilot plant are presented in the table of FIG. 8, which demonstrates the ability to precipitate copper from solution and effectively reduce ferric iron to ferrous iron. In all cases, the copper tenor in the effluent solution is below the maximum targeted limit (about 1 ppm Cu). However, in the case of the 5 g/L iron powder dosage, the maximum targeted ferric iron tenor (about 100 ppm) was not achieved. An increase to 7 grams per liter (gpl) iron powder dosage was determined to be acceptable as all targets were met.

After cementation the raffinate solution (post filtration), test work was performed regarding advances to ion exchange for cobalt recovery and upgrading. This ion exchange system consisted of series of columns containing ion exchange resin on a rotating carousel.

Raffinate containing cobalt, nickel, ferrous iron, and various other metals was fed to the IX system.

The resin has an affinity for cobalt, copper, ferric iron, and nickel. The copper and ferric concentrations are minor at this stage but nickel remains an important impurity. Cobalt is first eluted under conditions that do not promote nickel removal (lower acid strength). Cobalt was removed from the resin using a 13-25 g/L sulfuric acid solution followed by the subsequent removal of nickel using a 130 g/L sulfuric acid solution. The results from the IX pilot plant are presented in the table of FIG. 9.

It is important to note that cobalt not adsorbed on the resin is not lost as it is recycled to the raffinate pond for further use in the leaching process. Recycling of a portion of the eluted cobalt solution (pregnant leach solution-PLS) to the cobalt acid strip solution was successfully performed as a method to increase the cobalt tenor in the cobalt PLS. Higher cobalt tenors potentially improve the subsequent downstream cobalt recovery process.

Mixed Hydroxide Precipitate (MHP) was tested as a means to produce a high purity cobalt product. Magnesium oxide is added to the Co PLS produced from the ion exchange to produce cobalt hydroxide. Impurities such as nickel and zinc will also be precipitated in this process which is why they are removed before the MHP process.

The preliminary results from this test work are presented in the table of FIG. 10. It was observed that an increase in operating temperature of the MHP process increases the cobalt precipitation efficiency. In the case of test 4, a high cobalt recovery was achieved through the use of an elevated temperatures and MgO additions as a 40% pulp.

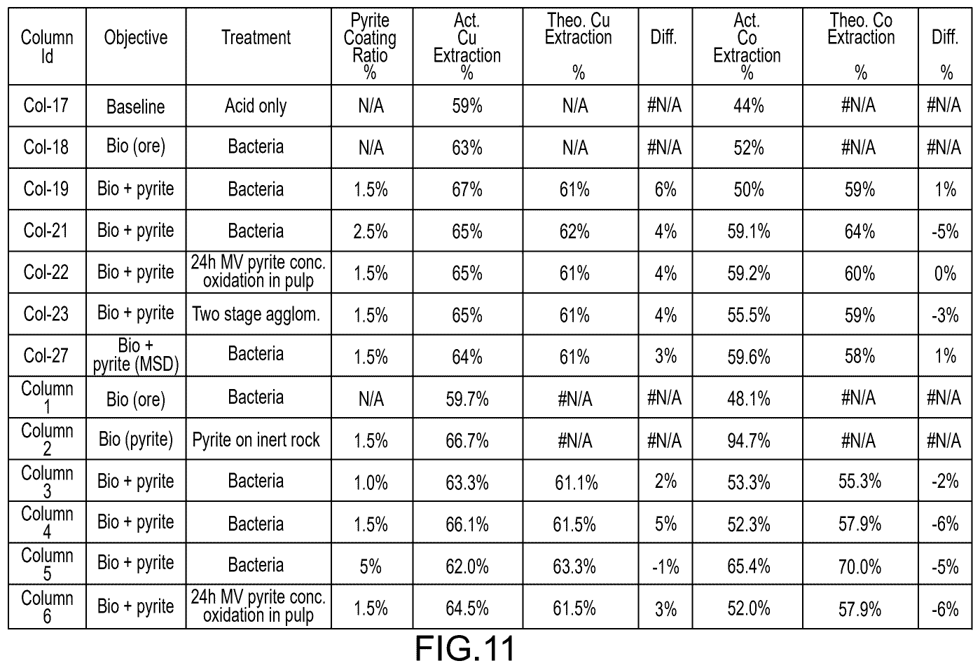

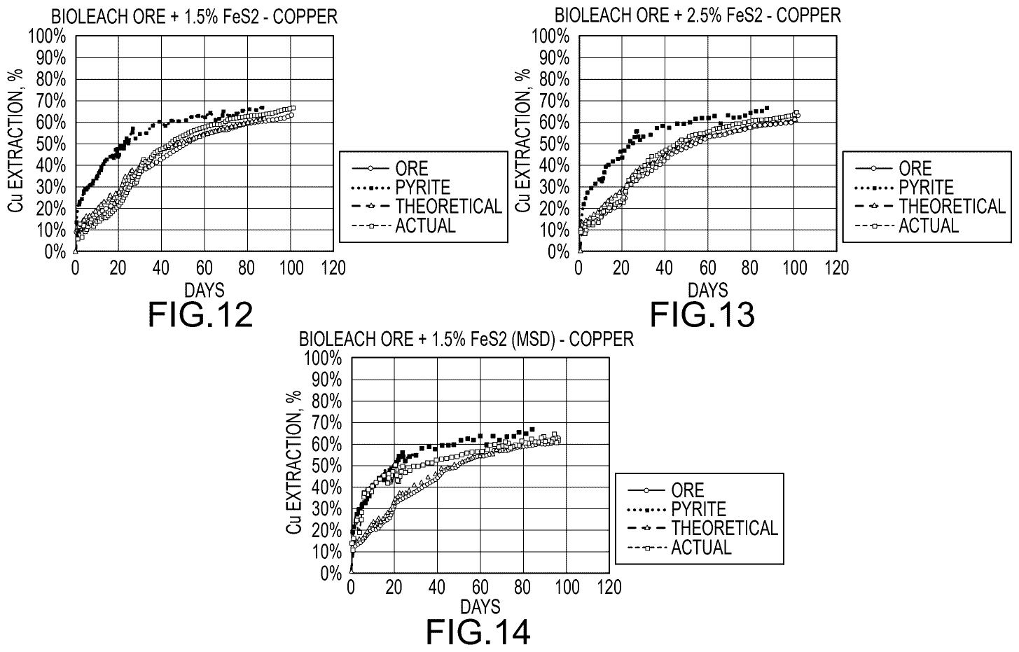

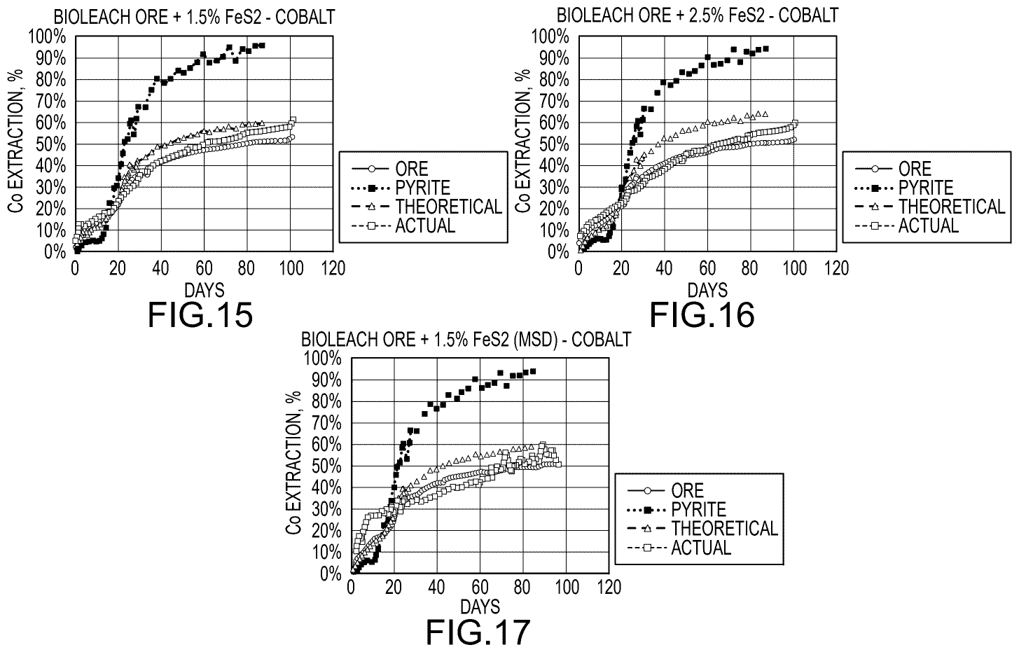

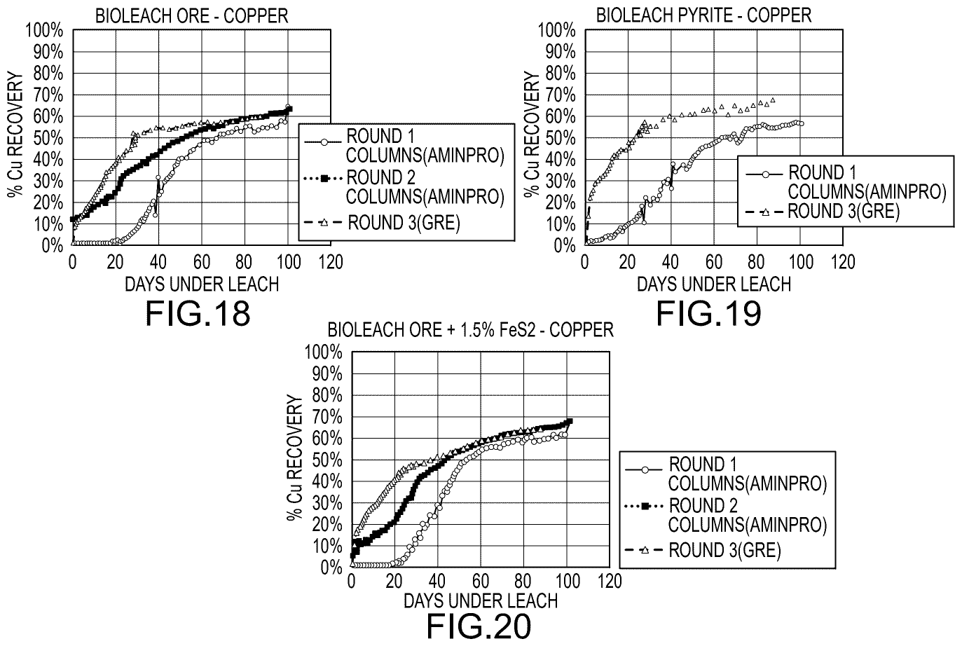

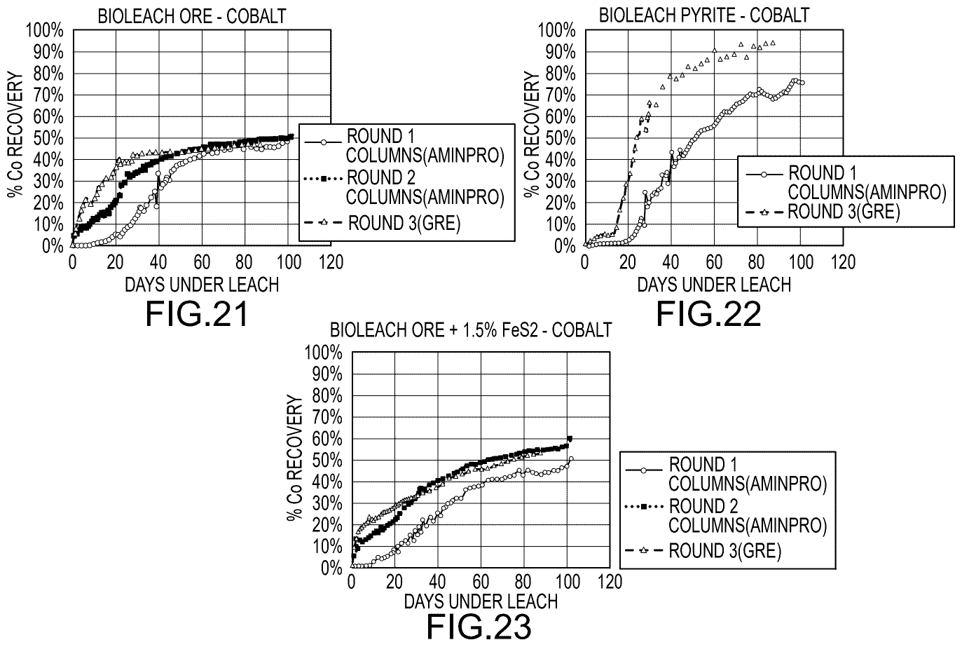

Several rounds of column leach test work was performed as set forth in FIG. 11-23. FIG. 11 is a table presenting the column leach test work, which are graphically represented in FIG. 12-23. In each of FIG. 12-17, a relationship is plotted for ore, pyrite, theoretical, and actual while in FIG. 18-23, a relationship is plotted for one or more of round 1, 2, or 3 columns. The objective (e.g., baseline, bioleach (pyrite), bioleach with pyrite, bioleach with pyrite (MSD), bioleach (ore), bioleach (pyrite), and bioleach with pyrite, treatment type (acid only, bacteria, 24 hr MV pyrite concentrate oxidation in pulp, two-stage agglomeration, and pyrite on inert rock, pyrite coating ratio (%) of pyrite coating on the appropriate substrate, actual and theoretical copper extraction (%) and difference therebetween (%) and actual and theoretical cobalt extraction (%) and difference therebetween (%). Referring to FIG. 11, column ID 17 represents the baseline test using acid only (without bacteria addition) while column IDs 1-6, 18-19, 21-23, and 27 performed bioleaching. The bioleaching was performed with various combinations of ore only, pyrite concentrate coated on ore, and pyrite concentrate on inert rock. Column ID 22 performed pre-oxidation of sulfides on the pyrite concentrate before agglomeration and column ID 23 performed agglomeration in two stages, with the first stage contacting the ore and concentrate mixture with sulfuric acid and nutrients the second stage contacting the ore and concentrate and acid mixture with inoculum. Two-stage agglomeration provides time for the sulfuric acid to react with carbonates in the ore before inoculum addition to avoid killing the microbe inoculum. As can be seen from the column leach results, bioleaching is superior to acid-only leaching in recovering copper and cobalt and coating of the scavenged pyrite concentrate on oxide ore substrates further enhances copper and cobalt recovery while generating sulfuric acid for recirculation through the heap.

A series of pilot plant runs were conducted to test various aspects of the process. The pilot plant included the unit operations of removing residual copper by iron powder precipitation from the SX raffinate to form a slurry, decantation of the slurry to remove precipitated copper and iron and form the copper barren solution 192, passing the copper barren solution 192 through a polishing filter to remove organics and suspended solids as a retentate, feeding the filtrate into a CCIX circuit comprising loading, eluting and regenerating columns to form a raffinate or cobalt barren solution 193 and cobalt loaded eluant 194, feeding the cobalt loaded eluant to an ion exchange circuit comprising loading, eluting, and regenerating columns to form a cobalt loaded raffinate and zinc loaded eluant, removing cobalt from solution by precipitation with MgO, and decantation of the slurry and filtration of the overflow to remove precipitated cobalt hydroxides.

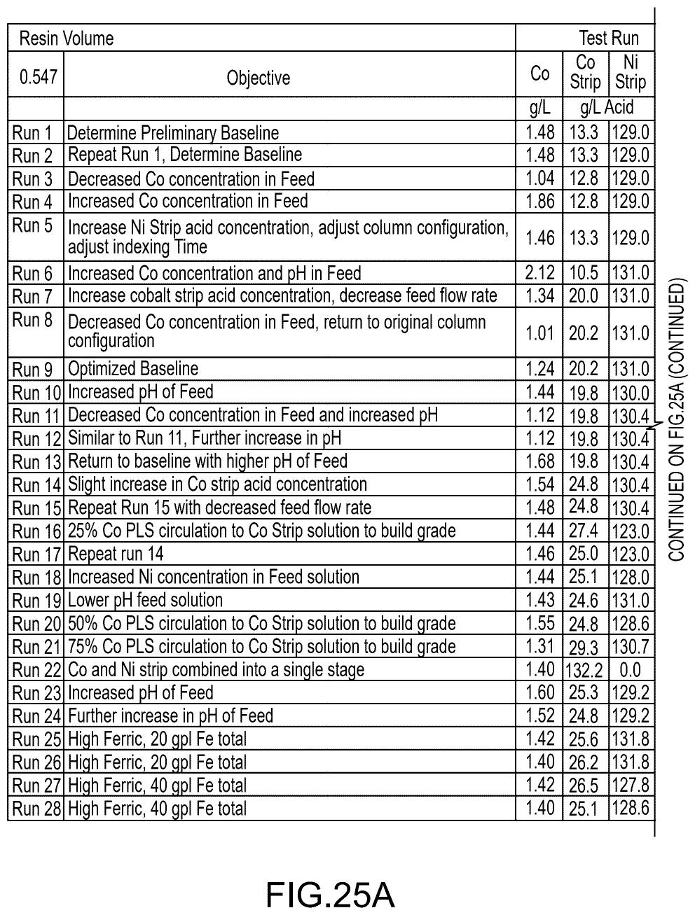

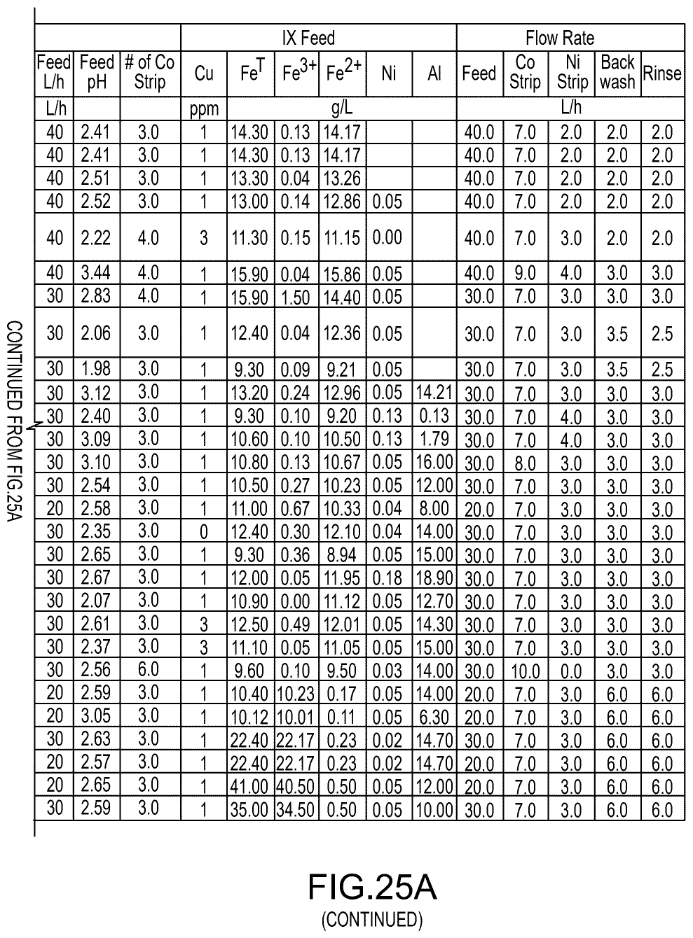

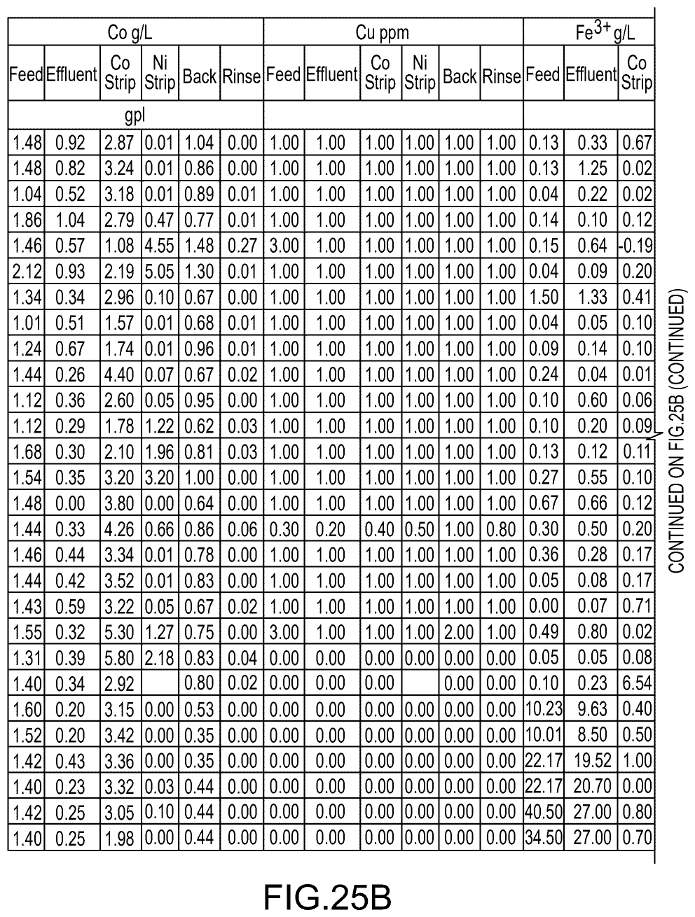

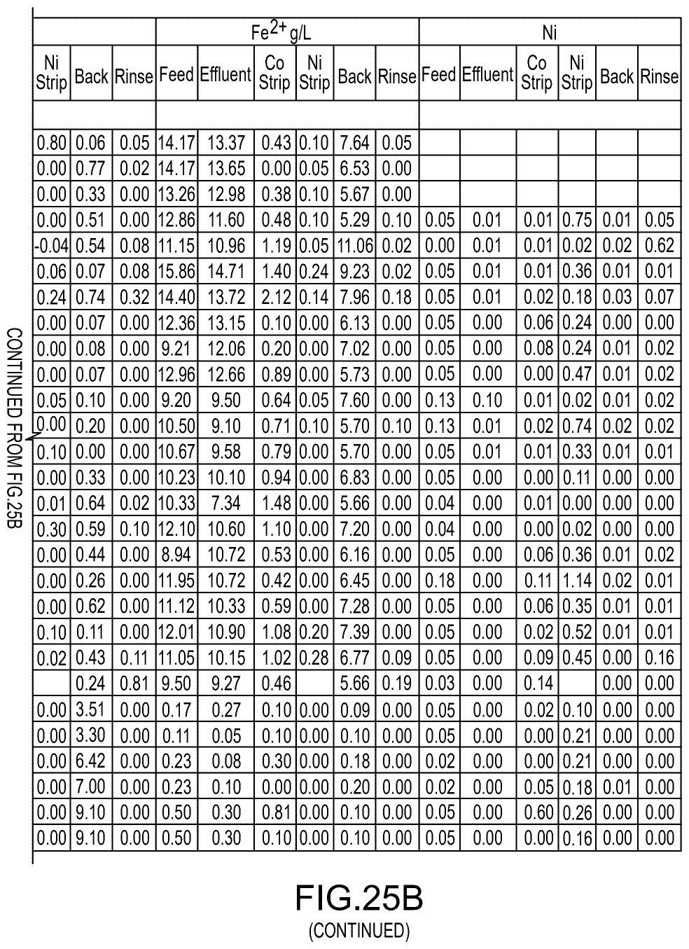

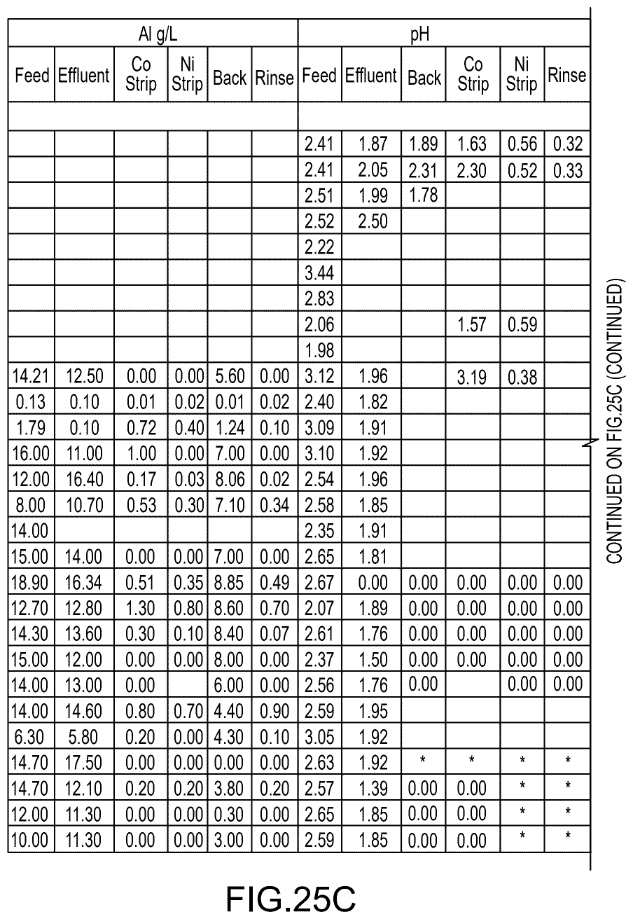

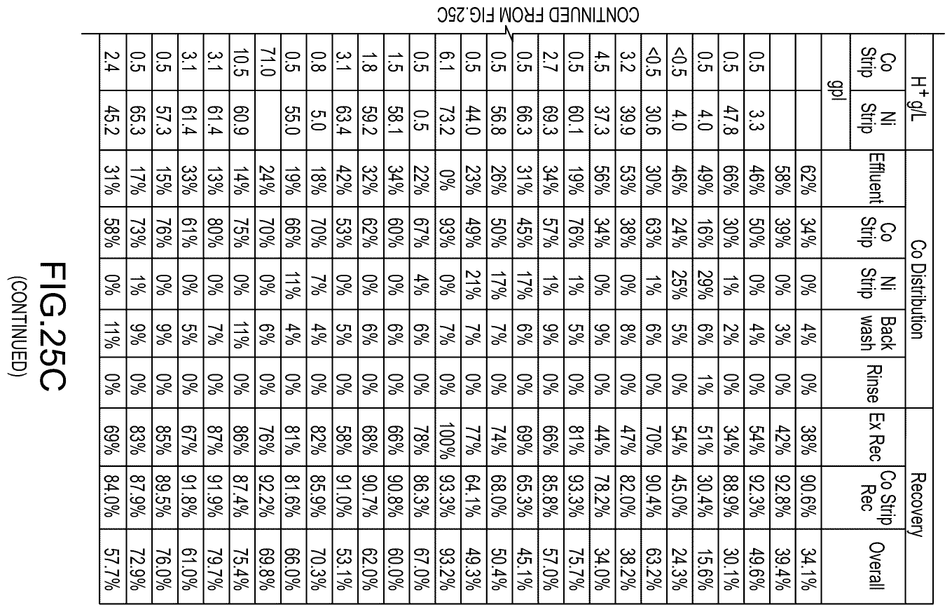

Turning to FIGS. 25A-C, the results of 28 pilot runs are presented. The table provides, for each run, the objective, overall pilot plant test run results (including cobalt concentration, sulfuric acid content of the cobalt and nickel stripping solutions, feed rate and pH, and number of cobalt stripping columns), ion exchange feed (including copper, total iron, ferric, ferrous, nickel and aluminum concentrations), flow rate (including flow rates for the pilot plant feed, cobalt stripping solution, nickel stripping solution, back wash solution, and rinse solution), cobalt concentration (including in the pilot plant feed, raffinate or effluent, cobalt stripping solution, nickel stripping solution, back wash solution and rinse solution), copper concentration (including in the pilot plant feed, raffinate or effluent, cobalt stripping solution, nickel stripping solution, back wash solution and rinse solution), ferric iron concentration (including in the pilot plant feed, raffinate or effluent, cobalt stripping solution, nickel stripping solution, back wash solution and rinse solution), ferrous iron concentration (including in the pilot plant feed, raffinate or effluent, cobalt stripping solution, nickel stripping solution, back wash solution and rinse solution), nickel concentration (including in the pilot plant feed, raffinate or effluent, cobalt stripping solution, nickel stripping solution, back wash solution and rinse solution), aluminum concentration (including in the pilot plant feed, raffinate or effluent, cobalt stripping solution, nickel stripping solution, back wash solution and rinse solution), pH (including in the pilot plant feed, raffinate or effluent, cobalt stripping solution, nickel stripping solution, back wash solution and rinse solution), acid concentration (in the cobalt and nickel stripping solutions), cobalt distribution (including in the pilot plant feed, raffinate or effluent, cobalt stripping solution, nickel stripping solution, back wash solution and rinse solution), and cobalt recovery (including extraction recovery, cobalt stripping recovery, and overall recovery). Pilot plant run 16 included a 25% cobalt pregnant leach solution recirculation to build cobalt grade, run 20 included a 50% cobalt pregnant leach solution recirculation to build cobalt grade, and run 21 included a 75% cobalt pregnant leach solution recirculation to build cobalt grade, and run 22 combined cobalt and nickel stripping into a single stripping stage.

As can be seen from the above pilot plant results, the process is robust and resistant to performance changes due to variations in feed grade and provides high efficiencies and copper and cobalt recoveries and high product purity levels while avoiding complex unit operations.

A number of variations and modifications of the disclosure can be used. It would be possible to provide for some features of the disclosure without providing others. The present disclosure, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process comprising:
floating a feed material comprising mainly non-sulfide gangue minerals and copper-containing sulfidic minerals, cobalt-containing sulfidic minerals, and iron pyrite at a pH of no more than about pH 10.5 to form a first separated portion comprising at least most of the copper-containing sulfidic minerals, cobalt-containing sulfidic minerals, and iron pyrite and a waste material;
floating the first separated portion at a pH of more than about pH 10.5 to form a second separated portion comprising at least most of the copper-containing sulfidic minerals and a third separated portion comprising at least most of the cobalt-containing sulfidic minerals and iron pyrite and a portion of the copper-containing sulfidic minerals;
contacting a lixiviant comprising H₂SO₄ and an oxidant with the third separated portion to form a pregnant leach solution comprising ferric iron and sulfuric acid from iron pyrite oxidation and, relative to the third separated portion, at least most of the copper in the copper-containing sulfidic minerals and cobalt in the cobalt-containing sulfidic minerals;
treating the pregnant leach solution, by ion exchange or solvent extraction, to form a rich solution comprising at least most of the copper in the pregnant leach solution and a raffinate comprising a portion of the copper and ferric iron and at least most of the cobalt in the pregnant leach solution;
removing, from at least a portion of the raffinate, at least most of the portion of the copper and ferric iron to form a purified raffinate; and
recovering at least most of the cobalt from the purified raffinate to form a cobalt-rich solution and cobalt-barren solution.

2. The process of claim 1, wherein the cobalt-containing sulfidic minerals comprise cobalt iron sulfides, wherein the contacting occurs in a non-stirred bioreactor leach in the presence of a suitable microbe inoculum, and further comprising:
combining, via agglomeration, the third separated portion containing at least most of the cobalt iron sulfides and iron pyrite with an unfloated material containing copper oxide and/or copper-containing sulfidic minerals to construct the non-stirred bioreactor, wherein the pregnant leach solution comprises at least most of the copper in the unfloated material.

3. The process of claim 2, wherein the unfloated material comprises copper oxide, wherein the unfloated material has a P₈₀ size ranging from about 7.5 to about 25 mm and the third separated portion has a P₈₀ size ranging from about 25 to about 100 micrometers, wherein a coating ratio of the unfloated material to the third separated portion ranges from about 5:1 to about 10:1 and wherein the sulfuric acid generated by pyrite bio-oxidation leaches copper from the copper oxide.

4. The process of claim 1, wherein an ion exchange resin or solvent extraction resin comprises chemical moieties of one or more of a chelating bis-picolyl amine resin, bis(2,4,4-trimethylpentyl)phosphinic acid, an aminophosphonate, and di-(2-ethyl hexyl)phosphoric acid and wherein the recovering comprises:
contacting the purified raffinate with an ion exchange resin or solvent extraction resin to adsorb at least most of the cobalt in the purified raffinate and form a cobalt barren solution; and
stripping, by an eluant, at least most of the cobalt from the ion exchange resin or solvent extraction resin to form the cobalt-rich solution.

1. The process of claim 4, wherein the contacting occurs in a non-stirred bioreactor leach, wherein the non-stirred bioreactor comprises a heap, wherein the raffinate comprises an organic reagent from the treating, and wherein at least most of the cobalt-barren solution is recycled to the contacting to rinse the heap to remove entrained aqueous cobalt and further comprising removing by dual media or membrane filters at least most of the organic reagent from the raffinate before the removing.

2. The process of claim 4, wherein the feed material further comprises a nickel iron sulfide mineral and zinc iron sulfide mineral, wherein at least most of the nickel iron sulfide mineral and zinc iron sulfide mineral is in the third separated portion, wherein the pregnant leach solution comprises at least most of the nickel in the nickel iron sulfide mineral and at least most of the zinc in the zinc iron mineral, wherein, in the recovering the cobalt is adsorbed on an ion exchange resin or solvent extraction extractant, and wherein the recovering of at least most of the cobalt from the purified raffinate comprises:
first eluting by a first eluant at least most of the cobalt from the ion exchange resin or solvent extraction extractant while leaving at least most of the nickel and zinc adsorbed on the ion exchange resin or solvent extraction extractant;
second eluting by a different second eluant at least most of the adsorbed zinc from the ion exchange resin or solvent extraction extractant; and
third eluting by a different third eluant at least most of the adsorbed nickel from the ion exchange resin or solvent extraction extractant, the first, second, and third eluants comprising different concentrations of sulfuric acid.

3. The process of claim 4, wherein the at least a portion of the raffinate in the removing is a bleed stream of the raffinate, wherein the feed material further comprises zinc iron sulfide and nickel iron sulfide, wherein at least most of the zinc iron sulfide and nickel iron sulfide is in the third separated portion, wherein the pregnant leach solution comprises at least most of the zinc and nickel in the third separated portion, wherein the cobalt-rich solution comprises at least most of the zinc and nickel in the pregnant leach solution, and wherein the recovering of at least most of the cobalt from the purified raffinate comprises:
eluting at least most of the cobalt and zinc from a first ion exchange resin or solvent extraction reagent while leaving at least most of the nickel adsorbed on the first ion exchange resin or solvent extraction reagent;
adsorbing at least most of the zinc on a different second ion exchange resin or solvent extraction reagent while passing at least most of the cobalt in a raffinate; and
eluting. by an eluant, at least most of the adsorbed zinc from the second ion exchange resin or solvent extraction reagent.

4. The process of claim 2, wherein the first separated portion is reground prior to combining and/or agglomerating with the unfloated material. to increase liberation of the iron pyrite, cobalt iron sulfides and copper-containing sulfidic minerals, and wherein the recovering comprises eluting adsorbed cobalt from an ion exchange resin to form the cobalt-rich solution, recycling a portion of the cobalt-rich solution to the eluting to increase a cobalt content of the cobalt-rich solution, and recycling at least a portion of the cobalt-barren solution to the contacting to remove entrained cobalt from a heap.

5. The process of claim 8, further comprising dump leaching copper from an unfloated copper- and cobalt-containing material and isolating a first ion exchange circuit receiving and recovering cobalt from the purified raffinate from a second ion exchange circuit receiving and recovering cobalt from a pregnant leach solution from dump leaching.

6. The process of claim 5, wherein the contacting occurs in a non-stirred bioreactor heap leach and wherein the cobalt-barren solution is mixed with cobalt-free make-up water comprising backwash from the dual media or membrane filters and recycled to the contacting to rinse the heap to remove entrained aqueous cobalt.

7. The process of claim 1, wherein the contacting occurs in a non-stirred bioreactor leach, wherein the non-stirred bioreactor is configured to have a permeability for irrigation flows ranging from about 5 liters per hour per square meter to about 20 liters per hour per square meter, wherein the raffinate comprises ferrous iron and aluminum and further comprising before the recovering converting at least most of the ferrous iron into ferrous iron, precipitating at least most of the ferric iron and aluminum at a pH of at least about pH 5, removing at least most of the precipitates from the raffinate, and adjusting a pH of the raffinate to a pH of from about pH 2 to about pH 3.5.

8. A process comprising:
providing a cobalt-containing material comprising non-sulfidic gangue minerals, copper-containing sulfidic minerals, cobalt-containing sulfidic minerals, and iron pyrite;
floating the cobalt-containing material at a pH of more than about pH 10.5 to form a first separated portion comprising at least most of the copper-containing sulfidic minerals in the cobalt-containing material and a second separated portion comprising a portion of the copper-containing sulfidic minerals and at least most of the cobalt-containing sulfidic minerals and iron pyrite in the cobalt-containing material.
contacting a lixiviant with the second separated portion to form a pregnant leach solution comprising ferric iron and sulfuric acid from iron pyrite oxidation and, relative to the second separated portion, at least most of the copper in the portion of the copper-containing sulfidic minerals and cobalt in the cobalt-containing sulfidic minerals;
treating the pregnant leach solution, by ion exchange and/or solvent extraction, to form a rich solution comprising at least most of the copper in the pregnant leach solution and a raffinate comprising at least most of the cobalt and a portion of the copper and ferric iron in the pregnant leach solution;
removing, from at least a portion of the raffinate, at least most of the copper and ferric iron to form a purified raffinate; and
recovering at least most of the cobalt from the purified raffinate to form a cobalt product and cobalt-barren solution.

9. The process of claim 12, wherein the cobalt-containing sulfidic minerals comprise cobalt iron sulfides, wherein the contacting occurs in a non-stirred bioreactor wherein the lixiviant comprises sulfuric acid, and wherein the providing comprises:
floating a feed material comprising mainly the non-sulfidic gangue minerals and copper-containing sulfidic minerals, cobalt iron sulfide, and iron pyrite at a pH of no more than about pH 10.5 to form the cobalt-containing material comprising at least most of the copper-containing sulfidic minerals, cobalt iron sulfides, and iron pyrite in the feed material and a waste material and further comprising:
combining, via agglomeration, the second separated portion containing at least most of the cobalt iron sulfides and iron pyrite with an unfloated material containing copper oxide and/or copper-containing sulfidic minerals and an inoculum to construct a heap of the non-stirred bioreactor, wherein the pregnant leach solution comprises at least most of the copper in the unfloated material.

14. The process of claim 13, wherein the unfloated material comprises copper oxide, wherein the unfloated material has a P₈₀ size ranging from about 7.5 to about 25 mm and the second separated portion has a P₈₀ size ranging from about 25 to about 100 micrometers, wherein a coating ratio of the unfloated material to the second separated portion ranges from about 5:1 to about 10:1, wherein the sulfuric acid generated by pyrite bio-oxidation leaches copper from the copper oxide wherein the recovering comprises eluting adsorbed cobalt from an ion exchange resin to form the rich solution, recycling a portion of the rich solution to the eluting to increase a cobalt content of the rich solution, and recycling at least a portion of the cobalt-barren solution to the heap to remove entrained cobalt from the heap, wherein the raffinate comprises an organic reagent from the treating, wherein the raffinate comprises ferrous iron and aluminum and further comprising before the recovering: removing by dual media or membrane filters at least most of the organic reagent from the raffinate, converting at least most of the ferrous iron into ferrous iron, precipitating at least most of the ferric iron and aluminum at a pH of at least about pH 5, removing at least most of the precipitates from the raffinate, and adjusting a pH of the raffinate to a pH of from about pH 2 to about pH 3.5.

15. The process of claim 12, wherein an ion exchange resin or solvent extraction resin comprises chemical moieties of one or more of a chelating bis-picolyl amine resin, bis(2,4,4-trimethylpentyl)phosphinic acid, an aminophosphonate, and di-(2-ethyl hexyl)phosphoric acid and wherein the recovering comprises:
contacting the purified raffinate with an ion exchange resin or solvent extraction reagent to adsorb at least most of the cobalt in the purified raffinate and form a cobalt barren solution; and
stripping, by an eluant, at least most of the cobalt from the ion exchange resin or solvent extraction reagent to form a cobalt-rich solution.

16. The process of claim 15, wherein the contacting comprises a heap leach and wherein at least most of the cobalt-barren solution is recycled to the contacting to rinse the heap to remove entrained aqueous cobalt and further comprising dump leaching copper from an unfloated copper- and cobalt-containing material and isolating a first ion exchange circuit receiving and recovering cobalt from the purified raffinate from a second ion exchange circuit receiving and recovering cobalt from a pregnant leach solution from dump leaching.

17. The process of claim 15, wherein the cobalt-containing material further comprises a nickel iron sulfide mineral, wherein at least most of the nickel iron sulfide mineral in the cobalt-containing material is in the second separated portion, wherein the pregnant leach solution comprises at least most of the nickel in the nickel iron sulfide mineral in the cobalt-containing material, wherein, in the recovering the cobalt is adsorbed on an ion exchange resin or solvent extraction extractant, and wherein the recovering of at least most of the cobalt from the purified raffinate comprises:
first eluting by a first eluant at least most of the cobalt from the ion exchange resin or solvent extraction extractant while leaving at least most of the nickel adsorbed on the ion exchange resin or solvent extraction extractant; and
second eluting by a different second eluant at least most of the adsorbed nickel from the ion exchange resin or solvent extraction extractant.

18. The process of claim 15, wherein the at least a portion of the raffinate in the removing is a bleed stream of the raffinate, wherein the cobalt-containing material further comprises zinc iron sulfide and nickel iron sulfide, wherein at least most of the zinc iron sulfide and nickel iron sulfide in the cobalt-containing material is in the second separated portion, wherein the pregnant leach solution comprises at least most of the zinc and nickel in the second separated portion, and wherein the recovering of at least most of the cobalt from the purified raffinate comprises:
eluting at least most of the cobalt and zinc from a first ion exchange resin or solvent exchange extractant while leaving at least most of the nickel adsorbed on the first ion exchange resin or solvent exchange extractant;
adsorbing at least most of the zinc on a second ion exchange resin or solvent exchange extractant while passing at least most of the cobalt in a raffinate;
eluting. by an eluant, at least most of the adsorbed zinc from the second ion exchange resin or solvent extraction extractant.

19. A process, comprising:
forming a pregnant leach solution comprising dissolved copper, cobalt, and iron by leaching a feed material comprising a copper-containing sulfidic material and cobalt-containing sulfidic material;
treating the pregnant leach solution, by ion exchange and/or solvent extraction, to form a rich solution comprising at least most of the copper in the pregnant leach solution and a raffinate comprising at least most of the cobalt and a portion of the copper and ferric iron in the pregnant leach solution;
recycling a first portion of the raffinate to the forming to dissolve further copper and cobalt and provide a cobalt concentration in the pregnant leach solution of at least about 1 g/L;
removing, from a second portion of the raffinate, at least most of the copper and ferric iron to form a purified raffinate, wherein the second portion comprises from about 5 to about 25% of the raffinate; and
recovering at least most of the cobalt from the purified raffinate to form a cobalt product and cobalt-barren solution.

20. The process of claim 19, wherein the forming comprises a heap leach and wherein at least most of the cobalt-barren solution is recycled to the heap leach to rinse the heap to remove entrained aqueous cobalt from recycle of the first portion of the raffinate.

21. The process of claim 19, wherein the recovering comprises eluting adsorbed cobalt from an ion exchange resin to form the rich solution and recycling a portion of the rich solution to the eluting to increase a cobalt content of the rich solution.
